(19) United States
(12) Patent Application Publication
(10) Pub. No.: US 2019/0289852 A1
(43) Pub. Date: Sep. 26, 2019

(54) AQUEOUS NEMATICIDAL COMPOSITIONS CONTAINING DISPERSANTS TO INHIBIT CRYSTAL GROWTH

(71) Applicant: Monsanto Technology LLC, St. Louis, MO (US)

(72) Inventors: Gregory Robert Nelson Johnston, O'Fallon, MO (US); David Edward Przybyla, O'Fallon, MO (US)

(73) Assignee: Monsanto Technology LLC, St. Louis, MO (US)

(21) Appl. No.: 16/361,531

(22) Filed: Mar. 22, 2019

Related U.S. Application Data
(60) Provisional application No. 62/647,012, filed on Mar. 23, 2018.

(51) Int. Cl. A01N 43/82; A01N 25/34; A01N 25/04

(52) U.S. Cl. CPC A01N 43/82; A01N 25/04; A01N 25/34

(57) ABSTRACT

Provided herein are aqueous nematicidal compositions comprising biologically active 3,5-disubstituted-1,2,4-oxadiazoles or salts thereof in combination with a dispersant component comprising a polyarylphenol alkoxylate and a second dispersant that are useful, for example, in the control of nematodes and exhibit reduced crystal growth when applied to a surface. Also provided herein are aqueous nematicidal compositions wherein the second dispersant comprises a lignin sulfonate, polyvinylpyrrolidone (PVP) polymers, polyvinylpyrrolidone/vinylacetate (PVP/VA) copolymer, maleic acid/olefin polymer, comb-graft copolymer, propylene oxide block copolymer, salts thereof, or combinations thereof.

### FIELD

Provided herein are aqueous nematicidal compositions comprising biologically active 3,5-disubstituted-1,2,4-oxadiazoles or salts thereof in combination with a dispersant component comprising a polyarylphenol alkoxylate and a second dispersant that are useful, for example, in the control of nematodes and that exhibit reduced crystal growth when applied to a surface, for example, the surface of a seed.

### BACKGROUND

Nematodes are active, flexible, elongate organisms that live on moist surfaces or in liquid environments, including films of water within soil and moist tissues within other organisms. Many species of nematodes have evolved to be very successful parasites of plants and animals and, as a result, are responsible for significant economic losses in agriculture and livestock.

Plant parasitic nematodes can infest all parts of the plant, including the roots, developing flower buds, leaves, and stems. Plant parasites can be classified on the basis of their feeding habits into a few broad categories: migratory ectoparasites, migratory endoparasites, and sedentary endoparasites. Sedentary endoparasites, which include root knot nematodes (Meloidogyne) and cyst nematodes (Globodera and Heterodera), can establish long-term infections within roots that may be very damaging to crops.

There is an urgent need in the industry for effective, economical, and environmentally safe methods of controlling nematodes. Continuing population growth, famines, and environmental degradation have heightened concern for the sustainability of agriculture.

Recently, a class of 3,5-disubstituted-1,2,4-oxadiazoles has been shown to exhibit potent, broad spectrum nematicidal activity. See generally U.S. Pat. Nos. 8,435,999 and 8,017,555, the contents of which are expressly incorporated herein by reference. The 3,5-disubstituted-1,2,4-oxadiazoles disclosed in U.S. Pat. Nos. 8,435,999 and 8,017,555 are generally characterized by low water solubility.

To be effective for use as a seed treatment composition, a nematicidal composition desirably satisfies several key requirements. The nematicidal active ingredient must be effectively incorporated into a composition having commercially acceptable storage stability. The composition should exhibit acceptable storage stability over a wide temperature range and even where the nematicidal active ingredient is present in a high loading, which reduces the required volume of the composition and, therefore, reduces the expense of storage and shipping. The nematicidal active ingredient must also be amenable to transfer from the composition to the surface of the seed, such that the desired loading can be efficiently achieved. Moreover, following application to the seed, it may be desirable for the nematicidal active ingredient to effectively migrate from the seed surface to the root zone of the surrounding soil. Compositions comprising solid particles of the 3,5-disubstituted-1,2,4-oxadiazole compounds suspended in an aqueous medium are generally disclosed in U.S. Patent Application Publication Nos. 2014/0187419 A1 and 2015/0342189 A1, the contents of which are expressly incorporated herein by reference. Recently, it has been observed that in some cases, seed coatings comprising the 3,5-disubstituted-1,2,4-oxadiazoles and related compounds disclosed in U.S. Pat. Nos. 8,435,999 and 8,017,555 may develop an irregular and unattractive appearance over time attributable to crystalline growth on the treated surface.

Accordingly, there is a need in the art to develop a composition that enables the efficient use of the abovementioned 3,5-disubstituted-1,2,4-oxadiazole compounds in large-scale, commercial agricultural applications, particularly in seed treatment applications to protect against nematode infestations, and reduces crystalline growth on a treated surface such as a seed.

### SUMMARY

Provided herein is an aqueous nematicidal composition, wherein the composition comprises a continuous aqueous phase comprising a dispersant component and a dispersed solid particulate phase comprising a 3,5-disubstituted-1,2,4-oxadiazole or a salt thereof, wherein the dispersant component comprises a polyarylphenol alkoxylate and a second dispersant. For example, in one embodiment the dispersant component comprises a sulfonated polyarylphenol ethoxylate or salt thereof and a second dispersant comprising a polyvinylpyrrolidone/vinylacetate (PVP/VA) copolymer.

In some embodiments, the polyarylphenol alkoxylate may be a sulfonated or phosphonated polyarylphenol alkoxylate. In some embodiments, the polyarylphenol alkoxylate may be a tristyrylphenol alkoxylate. In some embodiments, the polyarylphenol alkoxylate may be a polyarylphenol ethoxylate. In some embodiment, the polyarylphenol alkoxylate may be in the form of a salt. For example, the polyarylphenol alkoxylate may be in the form of an ammonium, potassium, sodium, trimethylamine, or triethylamine salt.

Also provided herein are aqueous nematicidal compositions wherein the second dispersant is selected from the group consisting of lignin sulfonates, polyvinylpyrrolidone (PVP) polymers, polyvinylpyrrolidone/vinylacetate (PVP/VA) copolymers, maleic acid/olefin polymers, comb-graft copolymers, propylene oxide block copolymers, salts thereof, and combinations thereof.

Another embodiment is directed to methods of preparing the nematicidal compositions described above. In one embodiment, the method comprises mixing the 3,5-disubstituted-1,2,4-oxadiazole compound, the dispersant component, and water to form an aqueous composition. In another embodiment the aqueous composition is wet milled to produce a milled composition having a reduced particle size.

Another embodiment is directed to methods of protecting a seed and/or the roots of a plant grown from the seed against damage by a nematode, the method comprising treating a seed with a seed treatment composition, the seed treatment composition comprising an aqueous nematicidal composition as described above.

Another embodiment is directed to a seed that has been treated with a seed treatment composition, the seed treatment composition comprising an aqueous nematicidal composition as described above.

A further embodiment is directed to a nematicidal coating composition adhered to the surface of a seed, wherein the composition comprises a continuous aqueous phase comprising a dispersant component and a dispersed solid particulate phase comprising a 3,5-disubstituted-1,2,4-oxadiazole or a salt thereof. The dispersant component comprises a polyarylphenol alkoxylate or salt thereof and a second dispersant.

Another embodiment is directed to an aqueous nematicidal composition exhibiting reduced crystal growth on application to a surface, such as a seed.

In one embodiment, a composition is directed to an aqueous nematicidal composition as described above, wherein the 3,5-disubstituted-1,2,4-oxadiazole compound is disubstituted with aryl and/or heteroaryl moieties.

In one embodiment, a composition is directed to an aqueous nematicidal composition as described above, wherein the 3,5-disubstituted-1,2,4-oxadiazole compound comprises a compound of Formula I or a salt thereof,

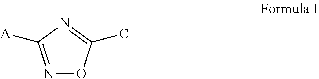

wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more substituents selected from the group consisting of F, Cl, CH₃, and OCF₃.

In another embodiment, a composition is directed to an aqueous nematicidal composition as described above, wherein the 3,5-disubstituted-1,2,4-oxadiazole compound comprises a compound of Formula II or a salt thereof,

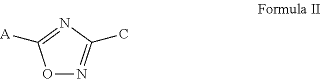

wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more with substituents selected from the group consisting of F, Cl, CH₃, and OCF₃.

Other objects and features will be in part apparent and in part pointed out hereinafter.

### DETAILED DESCRIPTION

Provided herein are aqueous nematicidal compositions comprising a 3,5-disubstituted-1,2,4-oxadiazole compound and a dispersant component comprising a polyarylphenol alkoxylate and a second dispersant that exhibit reduced crystal growth when applied to a surface, such as a seed. The aqueous nematicidal composition may be, for example, in the form of a suspension concentrate (SC) formulation comprising a continuous aqueous phase comprising the dispersant component and a dispersed solid particulate phase comprising a 3,5-disubstituted-1,2,4-oxadiazole or a salt thereof.

The aqueous nematicidal compositions described herein are sometimes referred to as “nematicidal compositions,” or more briefly as “compositions” or “the composition.” The aqueous nematicidal composition may also be referred to herein as a “seed treatment composition,” particularly in the context of seed treatment applications.

The dispersed solid particulate phase may be understood to be a solid phase comprising a 3,5-disubstituted-1,2,4-oxadiazole present as particles in an aqueous suspension. One example of such a dispersed solid particulate phase is that present in agricultural suspension concentrate formulations.

Nematicide

The compositions described herein generally comprise one or more 3,5-disubstituted-1,2,4-oxadiazole compounds. Such compounds are generally disclosed in U.S. Pat. Nos. 8,435,999 and 8,017,555 and U.S. Patent Application Publication Nos. 2014/0187419 A1 and 2015/0342189 A, the contents of which are expressly incorporated herein by reference.

In one embodiment, the 3,5-disubstituted-1,2,4-oxadiazole compound is disubstituted with aryl and/or heteroaryl moieties. In this context “aryl” refers to monocyclic, bicyclic or tricyclic aromatic groups containing from 6 to 14 ring carbon atoms and including, without limitation, optionally substituted phenyl. The term “heteroaryl” refers to groups having 5 to 14 ring atoms; 6, 10 or 14 π electrons shared in a cyclic array; and containing carbon atoms and 1, 2 or 3 oxygen, nitrogen or sulfur heteroatoms and including, without limitation, optionally substituted pyridyl, pyrazyl, thienyl, furanyl, oxazolyl and isoxazolyl.

For example, in one embodiment, the 3,5-disubstituted-1,2,4-oxadiazole compound comprises a compound of Formula I or a salt thereof,

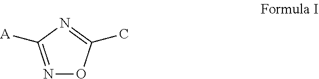

wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more substituents selected from the group consisting of F, Cl, CH₃, and OCF₃.

In a further embodiment, the 3,5-disubstituted-1,2,4-oxadiazole compound comprises a compound of Formula Ia or a salt thereof,

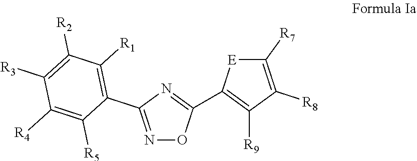

wherein R₁ and R₅ are independently selected from the group consisting of hydrogen, CH₃, F, Cl, Br, CF₃, OCH₃, and OCF₃; R₂ and R₄ are independently selected from the group consisting of hydrogen, F, Cl, Br, and CF₃; R₃ is selected from the group consisting of hydrogen. CH₃, CF₃, F, Cl, Br, OCF₃, OCH₃, CN, and C(H)O; R₇ and R₈ are independently selected from hydrogen and F; R₉ is selected from the group consisting of hydrogen, F, Cl, CH₃, and OCF₃; and E is O or S.

In another embodiment, the 3,5-disubstituted-1,2,4-oxadiazole compound comprises a compound of Formula Ib or a salt thereof,

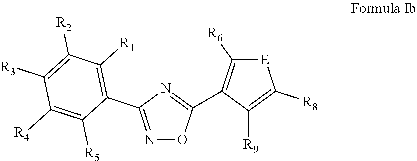

wherein R₁ and R₅ are independently selected from the group consisting of hydrogen, CH₃, F, Cl, Br, CF₃, OCH₃, and OCF₃; R₂ and R₄ are independently selected from the group consisting of hydrogen, F, Cl, Br, and CF₃; R₃ is selected from the group consisting of hydrogen. CH₃, CF₃, F, Cl, Br, OCF₃, OCH₃, CN, and C(H)O; R₈ is selected from hydrogen and F; R₆ and R₉ are independently selected from the group consisting of hydrogen, F, Cl, CH₃, and OCF₃; and E is O or S.

In another embodiment, the 3,5-disubstituted-1,2,4-oxadiazole compound comprises a compound of Formula II or a salt thereof,

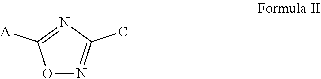

wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more with substituents selected from the group consisting of F, Cl, CH₃, and OCF₃.

In a further embodiment, the 3,5-disubstituted-1,2,4-oxadiazole compound comprises a compound of Formula IIa or a salt thereof.

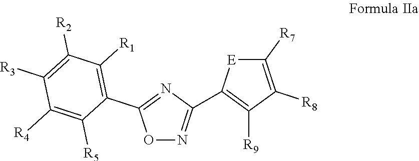

wherein R₁ and R₅ are independently selected from the group consisting of hydrogen, CH₃, F, Cl, Br, CF₃, OCH₃, and OCF₃; R₂ and R₄ are independently selected from the group consisting of hydrogen, F, Cl, Br, and CF₃; R₃ is selected from the group consisting of hydrogen, CH₃, CF₃, F, Cl, Br, OCF₃, OCH₃, CN, and C(H)O; R₇ and R₈ are independently selected from hydrogen and F; R₉ is selected from the group consisting of hydrogen. F, Cl, CH₃, and OCF₃; and E is O or S.

In another embodiment, the 3,5-disubstituted-1,2,4-oxadiazole compound comprises a compound of Formula IIb or a salt thereof,

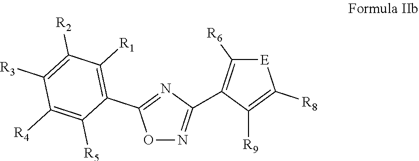

wherein R₁ and R₅ are independently selected from the group consisting of hydrogen, CH₃, F, Cl, Br, CF₃, OCH₃, and OCF₃; R₂ and R₄ are independently selected from the group consisting of hydrogen, F, Cl, Br, and CF₃; R₃ is selected from the group consisting of hydrogen, CH₃, CF₃, F, Cl, Br, OCF₃, OCH₃, CN, and C(H)O; R₈ is selected from hydrogen and F; R₆ and R₉ are independently selected from the group consisting of hydrogen, F, Cl, CH₃, and OCF₃; and E is O or S.

In one embodiment, the 3,5-disubstituted-1,2,4-oxadiazole compound comprises a compound of Formula Ia or a salt thereof. Non-limiting examples of species include tioxazafen (i.e., 3-phenyl-5-(thiophen-2-yl)-1,2,4-oxadiazole) of Formula Ia-i,

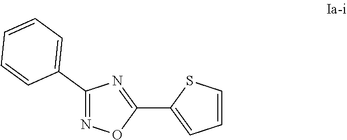 [SMILES: c1ccc(-c2noc(-c3cccs3)n2)cc1]

3-(4-chlorophenyl)-5-(furan-2-yl)-1,2,4-oxadiazole of Formula Ia-ii,

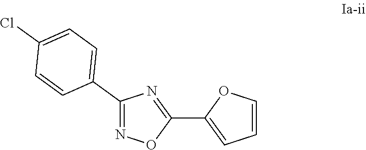 [SMILES: Clc1ccc(-c2noc(-c3ccco3)n2)cc1]

3-(4-chloro-2-methylphenyl)-5-(furan-2-yl)-1,2,4-oxadiazole of Formula Ia-iii,

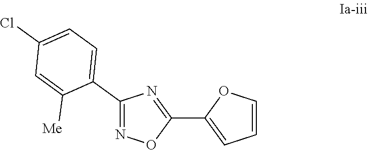 [SMILES: Cc1cc(Cl)ccc1-c1noc(-c2ccco2)n1]

and 5-(furan-2-yl)-3-phenyl-1,2,4-oxadiazole of Formula Ia-iv.

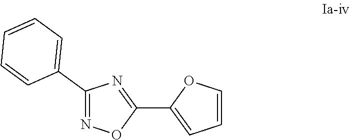 [SMILES: c1ccc(-c2noc(-c3ccco3)n2)cc1]

In another embodiment, the 3,5-disubstituted-1,2,4-oxadiazole compound comprises a compound of Formula Ib or a salt thereof. Non-limiting examples of species include 3-(4-bromophenyl)-5-(furan-3-yl)-1,2,4-oxadiazole of Formula Ib-i,

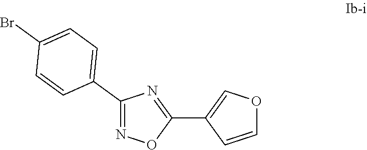 [SMILES: Brc1ccc(-c2noc(-c3ccoc3)n2)cc1]

and 3-(2,4-difluorophenyl)-5-(thiophen-3-yl)-1,2,4-oxadiazole of Formula (Ib-ii).

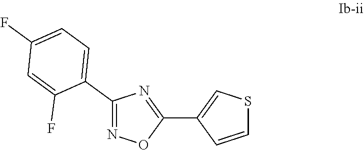 [SMILES: Fc1ccc(-c2noc(-c3ccsc3)n2)c(F)c1]

In another embodiment, the 3,5-disubstituted-1,2,4-oxadiazole compound comprises a compound of Formula IIa or a salt thereof. Non-limiting examples of species include 3-(thiophen-2-yl)-5-(p-tolyl)-1,2,4-oxadiazole of Formula IIa-i,

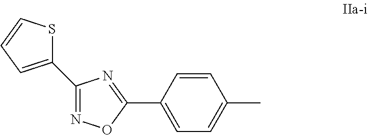 [SMILES: Cc1ccc(-c2nc(-c3cccs3)no2)cc1]

5-(3-chlorophenyl)-3-(thiophen-2-yl)-1,2,4-oxadiazole of Formula (IIa-ii),

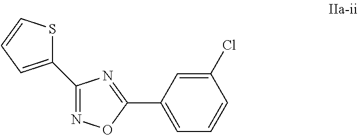 [SMILES: Clc1cccc(-c2nc(-c3cccs3)no2)c1]

and 5-(4-chloro-2-methylphenyl)-3-(furan-2-yl)-1,2,4-oxadiazole of Formula (IIa-iii).

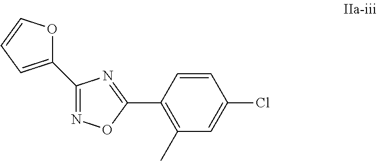 [SMILES: Cc1cc(Cl)ccc1-c1nc(-c2ccco2)no1]

In one embodiment, the 3,5-disubstituted-1,2,4-oxadiazole comprises a compound selected from the group consisting of 3-phenyl-5-(thiophen-2-yl)-1,2,4-oxadiazole, 3-(4-chlorophenyl)-5-(furan-2-yl)-1,2,4-oxadiazole, 3-(4-chloro-2-methylphenyl)-5-(furan-2-yl)-1,2,4-oxadiazole, 3-(4-bromophenyl)-5-(furan-3-yl)-1,2,4-oxadiazole, and 3-(2,4-difluorophenyl)-5-(thiophen-3-yl)-1,2,4-oxadiazole. In one embodiment, the 3,5-disubstituted-1,2,4-oxadiazole comprises 3-phenyl-5-(thiophen-2-yl)-1,2,4-oxadiazole.

In another embodiment, the 3,5-disubstituted-1,2,4-oxadiazole comprises a compound selected from the group consisting of 3-(4-bromophenyl)-5-(furan-3-yl)-1,2,4-oxadiazole and 3-(2,4-difluorophenyl)-5-(thiophen-3-yl)-1,2,4-oxadiazole.

In another embodiment, the 3,5-disubstituted-1,2,4-oxadiazole comprises a compound selected from the group consisting of 3-(thiophen-2-yl)-5-(p-tolyl)-1,2,4-oxadiazole, 5-(3-chlorophenyl)-3-(thiophen-2-yl)-1,2,4-oxadiazole, and 5-(4-chloro-2-methylphenyl)-3-(furan-2-yl)-1,2,4-oxadiazole.

The aqueous nematicidal composition in some embodiments comprises at least about 10%, at least about 15%, at least about 20%, at least about 25%, at least about 30%, at least about 35%, at least about 40%, at least about 45%, or at least about 50% by weight of the 3,5-disubstituted-1,2,4-oxadiazole compound as described above. For example, the aqueous nematicidal composition in some embodiments comprises from about 10% to about 50%, from about 15% to about 50%, from about 20% to about 50%, from about 25% to about 50%, from about 30% to about 50%, from about 35% to about 50%, or from about 40% to about 50% by weight of the 3,5-disubstituted-1,2,4-oxadiazole compound as described above.

In further embodiments, the aqueous nematicidal composition comprises at least about 10%, at least about 15%, at least about 20%, at least about 25%, at least about 30%, at least about 35%, at least about 40%, at least about 45%, or at least about 50% by weight of 3-phenyl-5-(thiophen-2-yl)-1,2,4-oxadiazole of Formula Ia-i as described above. For example, the aqueous nematicidal composition in some embodiments comprises from about 10% to about 50%, from about 15% to about 50%, from about 20% to about 50%, from about 25% to about 50%, from about 30% to about 50%, from about 35% to about 50%, or from about 40% to about 50% by weight of 3-phenyl-5-(thiophen-2-yl)-1,2,4-oxadiazole of Formula Ia-i.

In some embodiments, the aqueous nematicidal composition comprises the 3,5-disubstituted-1,2,4-oxadiazole compound in a concentration of at least about 100 g/L, at least about 200 g/L, at least about 250 g/L, at least about 300 g/L, at least about 350 g/L, at least about 400 g/L, at least about 450 g/L, at least about 500 g/L, at least about 550 g/L, at least about 600 g/L, at least about 650 g/L, or at least about 700 g/L. For example, the 3,5-disubstituted-1,2,4-oxadiazole concentration ranges from about 400 g/L to about 700 g/L, from about 450 g/L to about 700 g/L, or from about 500 g/L to about 700 g/L.

In further embodiments, the aqueous nematicidal composition comprises 3-phenyl-5-(thiophen-2-yl)-1,2,4-oxadiazole of Formula Ia-i in a concentration of at least about 100 g/L, at least about 200 g/L, at least about 250 g/L, at least about 300 g/L, at least about 350 g/L, at least about 400 g/L, at least about 450 g/L, at least about 500 g/L, at least about 550 g/L, at least about 600 g/L, at least about 650 g/L, or at least about 700 g/L. For example, the aqueous nematicidal compositions may comprise 3-phenyl-5-(thiophen-2-yl)-1,2,4-oxadiazole of Formula Ia-i in a concentration from about 400 g/L to about 700 g/L, from about 450 g/L to about 700 g/L, or from about 500 g/L to about 700 g/L.

Particle Size

The compositions described herein in the form of a suspension concentrate comprise a continuous aqueous phase and a dispersed solid phase comprising solid particulates of the 3,5-disubstituted-1,2,4-oxadiazole compound. The solid 3,5-disubstituted-1,2,4-oxadiazole particulates may have a particle size distribution selected to enhance dispersibility of the particles in the composition and improve the stability of the composition.

The particle size can be reduced by conventional means, for example as set forth in U.S. Patent Application Publication Nos. 2014/0187419 A1 and 2015/0342189 A1, which are incorporated herein by reference. In some embodiments, the median particle size of the dispersed solid phase is less than about 50 μm, less than about 30 μm, less than about 20 μm, less than about 10 μm, less than about 5 μm, less than about 4 μm, less than about 3 μm, less than about 2 μm, or less than about 1 μm. For example, in some embodiments, the median particle size of the dispersed solid phase is from about 0.5 μm to about 10 μm, from about 1 μm to about 5 μm, from about 1 μm to about 4 μm, from about 1 μm to about 3 μm, or from about 1 μm to about 2 μm. In other embodiments, the median particle size of the dispersed solid phase is from about 0.5 μm to about 5 μm, from about 1 μm to about 4 μm, from about 2 μm to about 4 μm, or from about 2.5 μm to about 3.5 μm.

In some embodiments, the mean particle size of the dispersed solid phase is less than about 20 μm, less than about 10 μm, less than about 5 μm, less than about 4 μm, less than about 3 μm, less than about 2 μm, or less than about 1 μm. For example, in some embodiments, the mean particle size of the dispersed solid phase is from about 0.5 μm to about 20 μm, from about 0.5 μm to about 10 μm, from about 1 μm to about 5 μm, from about 1 μm to about 4 μm, from about 1 μm to about 3 μm, or from about 1 μm to about 2 μm. In other embodiments, the mean particle size of the dispersed solid phase may be from about 0.5 μm to about 5 μm, from about 0.5 μm to about 4 μm, from about 0.5 μm to about 3 μm, from about 0.5 μm to about 2 μm, or from about 0.5 μm to about 1 μm.

Likewise, in some embodiments, the dispersed solid phase may have a polydispersity index, defined as the arithmetic mean of the particle size divided by the median particle size, of less than about 10. In some embodiments, the polydispersity index is less than about 5, less than about 2, or less than about 1.5. In some embodiments, the polydispersity index typically falls within the range of from about 1 to about 2.

Dispersant(s)

It is believed that when applied to the surface of a substrate, such as a seed, 3,5-disubstituted-1,2,4-oxadiazole compounds as described herein exhibit a susceptibility to crystallize on the application surface. The formation of crystals on the surface of a treated seed results in an irregular and undesirable appearance. Further, crystal formation on the surface of a seed may present difficulties when the seeds are planted using agriculture planting equipment. The problem of crystal formation is particularly acute when treated seeds are stored in a confined space, such as a bag, which is often used to transport and store treated seeds prior to use.

The dispersant component comprising a polyarylphenol alkoxylate and a second dispersant, sometimes referred to as the “dispersant package,” has been found to inhibit and/or reduce crystal growth associated with 3,5-disubstituted-1,2,4-oxadiazole compounds when applied to the surface of a seed or other substrate. Examples of substrates include, but are not limited to, any surface of plant or plant material such as roots, leaves, stems, flowers, trunks, needles, cuttings, or plant propagation material, in particular seeds. In one embodiment the 3,5-disubstituted-1,2,4-oxadiazole compounds, in particular, 3-phenyl-5-(thiophen-2-yl)-1,2,4-oxadiazole of Formula Ia-i, are applied to roots. Without being bound to a particular theory, it is believed that the presence of the polyarylphenol alkoxylate in the dispersant package aids in reducing the viscosity of the composition. Additionally, the aromatic functional groups of the polyarylphenol alkoxylate are thought to enable strong π-π interactions with the aromatic rings in the 3,5-disubstituted-1,2,4-oxadiazole compound. This viscosity reduction and π-π interaction are believed to enhance on-seed performance by allowing for better coating of the seed and inhibiting crystal formation of the 3,5-disubstituted-1,2,4-oxadiazole once applied to a seed.

In some embodiments, the polyarylphenol alkoxylate may be a tristyrylphenol alkoxylate. In some embodiments, the polyarylphenol alkoxylate may be sulfonated or phosphonated. For example, the polyarylphenol alkoxylate may be a tristyrylphenol alkoxylate, a sulfonated tristyrylphenol alkoxylate, or a phosphonated tristyrylphenol alkoxylate. In some embodiments, the polyarylphenol alkoxylate may be a polyarylphenol ethoxylate. For example, the polyarylphenol alkoxylate may be a tristyrylphenol ethoxylate, a sulfonated tristyrylphenol ethoxylate, or a phosphonated tristyrylphenol ethoxylate.

In yet another embodiment, the polyarylphenol alkoxylate may be in the form of a salt. For example, the polyarylphenol alkoxylate may be in the form of an ammonium, potassium, sodium, trimethylamine, or triethylamine salt. In some embodiments, the polyarylphenol alkoxylate may be the ammonium, potassium, sodium, trimethylamine, or triethylamine salt of sulfonated or phosphonated polyarylphenol ethoxylate.

In one embodiment, the polyarylphenol alkoxylate is selected from the group consisting of polyarylphenol ethoxylates, sulfonated polyarylphenol ethoxylates, phosphonated polyarylphenol ethoxylates, tristyrylphenol ethoxylates, sulfonated tristyrylphenol ethoxylates, and phosphonated tristyrylphenol ethoxylates, each in form of an ammonium, potassium, sodium, trimethylamine, or triethylamine salt, and combinations thereof.

Non-limiting examples of commercially available polyarylphenol alkoxylates include, for example, Tersperse 2202. Non-limiting examples of commercially available tristyrylphenol ethoxylates include, for example, Soprophor S25/80 and Soprophor 3d 33. Non-limiting examples of commercially available sulfonated polyarylphenol ethoxylates include, for example, 2,4,6-tris[1-(phenyl)ethyl]phenyl-omega-hydroxy-poly(oxyethylene) sulfate (Soprophor 4D 384). Non-limiting examples of commercially available phosphonated tristyrylphenol ethoxylates include, for example, Soprophor FLK. TERSPERSE 2202 (available from Huntsman Corporation) comprises ethoxylated tristyrylphenol phosphate, triethanolamine (TEA) salt. SOPROPHOR is a brand name commercially available from Solvay SA or Rhodia Solvay Group. SOPROPHOR S25/80 comprises tristyrylphenol ethoxylate; SOPROPHOR FLK comprises ethoxylated tristyrylphenol phosphate, potassium salt; SOPROPHOR 4D 384 comprises polyarylphenylether sulfate, ammonium salt.

As set forth herein, the polyarylphenol alkoxylate is combined with a second dispersant. The presence of a second dispersant in the dispersant package is believed to contribute to the inhibition and/or reduction of crystal formation of the 3,5-disubstituted-1,2,4-oxadiazole when applied a seed or other application surface as well as provide for compositional stability. The second dispersant may be selected from the group consisting of lignin sulfonates, polyvinylpyrrolidone (PVP) polymers, polyvinylpyrrolidone/vinylacetate (PVP/VA) copolymers, maleic acid/olefin polymers, comb-graft copolymers, propylene oxide block copolymers, salts thereof, and combinations thereof.

Suitable lignin sulfonates may comprise, for example, sodium lignosulfonate, calcium lignosulfonate, ammonium lignosulfonate, magnesium lignosulfonate, potassium lignosulfonate, or sulfomethylated lignosulfonate. Non-limiting examples of commercially available lignin sulfonates include, for example, GREENSPERSE S7. REAX 907, POLYFON O, HYACT, KRAFTSPERSE 25M, and BORRESPERSE. GREENSPERSE S7 and KRAFTSPERSE 25M (commercially available from Ingevity) comprise sodium lignosulfonate. REAX 907 and HYACT (commercially available from Ingevity) comprise kraft lignin. POLYFON O comprises sodium lignosulfonate.

Suitable polyvinylpyrrolidone (PVP) polymers and polyvinylpyrrolidoneivinylacetate (PVP/VA) copolymers may, for example, have an average molecular weight of at least about 40,000, at least about 45,000, at least about 50,000, at least about 55,000, at least about 60,000, at least about 65,000, or at least about 70.000. For example, in certain embodiments, the polyvinylpyrrolidone (PVP) polymers and polyvinylpyrrolidone/vinylacetate (PVP/VA) copolymers may have an average molecular weight of about 51,000. In another embodiment, the polyvinylpyrrolidone (PVP) polymers and polyvinvlpyrrolidone/vinylacetate (PVP/VA) copolymers may have an average molecular weight of about 65,000. In one embodiment, the polyvinylpyrrolidone (PVP) polymers and polyvinylpyrrolidoneivinylacetate (PVP/VA) copolymers may have an average molecular weight of from about 40,000 to about 100,000, from about 40,000 to about 90,000, from about 40,000 to about 80,000, from about 45,000 to about 75,000, from about 45,000 to about 70,000, from about 45,000 to about 65,000, from about 45,000 to about 60,000, from about 50,000 to about 60,000, or from about 50,000 to about 55,000. In another embodiment, the poly vinvlpyrrolidone (PVP) polymers and polyvinylpyrrolidone/vinvlacetate (PVP/VA) copolymers may have an average molecular weight of from about 45,000 to about 80,000, from about 50,000 to about 80,000, from about 55,000 to about 80,000, from about 55,000 to about 75,000, from about 60,000 to about 75,000, or from about 60,000 to about 70.000.

Suitable polyvinylpyrrolidone (PVP) polymers may comprise, for example, unbranched homopolymers of polyvinylpyrrolidone or alkylated polyvinylpyrrolidone. Non-limiting examples of commercially available polyvinylpyrrolidone (PVP) polymers include, for example, EASY SPERSE 20, and SOKALAN K 30, AGRIMER 30, and AGRIMER 60L.

Non-limiting examples of commercially available polyvinylpyrrolidone/vinylacetate (PVP/VA) copolymers include, for example, SOKALAN VA 64, AGRIMER VA6, and AGRIMER VA7W. SOKALAN VA 64 (commercially available from Azelis) comprises polyvinylpyrrolidone. EASY SPERSE P-20 (commercially available from Ashland) comprises composite polyvinyl pyrrolidone (PVP) and methyl vinyl ether/maleic acid half ester. AGRIMER VA 6W (commercially available from Toronto Research Chemicals) comprises copovidone.

Suitable maleic acid/olefin polymers may comprise, for example, diisobutene, acrylic acid, or olefin copolymers. Non-limiting examples of commercially available maleic acid/olefin polymers include, for example, SOKALAN CP 9, SOKALAN CP 5, and AGRIMER VEMA H-2200L. SOKALAN CP 9 (commercially available from BASF) comprises a co-polymer of metacic acid and olefin.

Suitable comb-graft copolymers may comprise, for example, an acrylic graft copolymer. Non-limiting examples of commercially available comb-graft copolymers include, for example, ATLOX 4913, TERSPERSE 2500, and AGNIQUE CP-72L. ATLOX 4913 (commercially available from Croda) comprises non-ionic acrylic copolymer.

Suitable propylene oxide block copolymers may comprise, for example, ethylene oxide, propylene oxide, or amine based block copolymers. Non-limiting examples of commercially available propylene oxide block copolymers include, for example, PLURONIC L1060, PLURONIC L64, TETRONIC 1107, PLURONIC P104 and PLURIOL P106. PLURONIC L1060 and PLURIOL P106 (commercially available from BASF) comprise an ethylene oxide/propylene oxide block copolymer.

The second dispersant may be selected from the group consisting of sodium lignosulfonates, calcium lignosulfonates, ammonium lignosulfonates, magnesium lignosulfonates, potassium lignosulfonates, or sulfomethylated lignosulfonates, diisobutene, acrylic acid, or olefin copolymers, acrylic graft copolymers, unbranched homopolymers of polyvinylpyrrolidone or alkylated polyvinylpyrrolidone, polyvinylpyrrolidone/vinylacetate (PVP/VA) copolymers having an average molecular weight of from about 40,000 to about 100,000, ethylene oxide, propylene oxide, or amine based block copolymers, and combinations thereof.

The dispersant package may comprise a combination of one or more of the above-mentioned polyarylphenol alkoxylates and one or more of the above-mentioned second dispersants.

For example, and without limitation, in certain specific embodiments, the polyarylphenol alkoxylate is a phosphonated tristyrylphenol ethoxylate and the dispersant package further comprises a second dispersant selected from the group consisting of lignin sulfonates, polyvinylpyrrolidone (PVP) polymers, polyvinylpyrrolidone/vinylacetate (PVP/VA) copolymers, and maleic acid/olefin polymers.

In further specific embodiments, the polyarylphenol alkoxylate is a tristyrylphenol ethoxylate and the dispersant package further comprises a second dispersant selected from the group consisting of lignin sulfonates and maleic acid/olefin polymers.

In still further non-limiting, specific embodiments, the polyarylphenol alkoxylate is a sulfonated polyarylphenol ethoxylate and the dispersant package further comprises a second dispersant selected from the group consisting of lignin sulfonates, polyvinylpyrrolidone (PVP) polymers, polyvinylpyrrolidone/vinylacetate (PVP/VA) copolymers, and maleic acid/olefin polymers.

In one embodiment, the polyarylphenol alkoxylate is a sulfonated polyarylphenol ethoxylate and the second dispersant is a polyvinylpyrrolidone/vinylacetate (PVP/VA) copolymer. For example, the polyanlphenol alkoxylate is 2,4,6-tris[1-(phenyl)ethyl]phenyl-omega-hydroxy-poly(oxyethylene) sulfate or the ammonium salt of 2,4,6-tris[1-(phenyl)ethyl]phenyl-omega-hydroxy-poly(oxyethylene) sulfate and the second dispersant is a polyvinylpyrrolidone/vinylacetate (PVP/VA) copolymer.

In certain further embodiments, the dispersant package may comprise an optional third dispersant selected from the group consisting of lignin sulfonates, polyvinylpyrrolidone (PVP) polymers, polyvinylpyrrolidone/vinylacetate (PVP/VA) copolymers, maleic acid/olefin polymers, comb-graft copolymers, propylene oxide block copolymers, salts thereof, and combinations thereof. For example, and without limitation, in certain specific embodiments, the dispersant package includes a third dispersant comprising a maleic acid/olefin polymer.

In one embodiment, the dispersant package comprising a polyarylphenol alkoxylate and second surfactant comprises at least about 0.5 wt %, at least about 1 wt %, at least about 1.5 wt %, at least about 2 wt %, at least about 3 wt %, at least about 6 wt %, at least about 10 wt %, or at least about 20 wt % of the composition. For example, the dispersant package comprises from about 0.5 wt % to about 20 wt %, from about 0.5 wt % to about 10 wt %, from about 1 wt % to about 9 wt %, from about 1.5 wt % to about 8 wt %, or from about 2 wt % to about 8 wt % of the composition. In another embodiment, the dispersant package comprises from about 0.5 wt % to about 10 wt %, from about 1 wt % to about 9 wt %, from about 1.5 wt % to about 8 wt %, or from about 1.5 wt % to about 7 wt % of the composition.

In some embodiments, the second dispersant may comprise from about 0.05 wt % to about 10 wt %, from about 0.1 wt % to about 10 wt %, from about 0.5 wt % to about 8 wt %, from about 1 wt % to about 5 wt %, or from about 2 wt % to about 5 wt % of the composition.

In certain embodiments, the ratio of polyarylphenol alkoxylate to second dispersant in the dispersant package, on a weight basis, is from about 1:5 to about 10:1, from about 1:4 to about 9:1, from about 1:2 to about 8:1, from about 1:1 to about 5:1, from about 2:1 to about 5:1, or from about 2:1 to about 3:1.

In some embodiments, the ratio of the dispersant package to the 3,5-disubstituted-1,2,4-oxadiazole compound or a salt thereof, on a weight basis, is from about 10:1 to about 1:100, from about 5:1 to about 1:50, from about 1:1 to about 1:50, from about 1:2 to about 1:40, from about 1:4 to about 1:30, from about 1:5 to about 1:30, from about 1:5.5 to about 1:25, from about 1:6 to about 1:24, from about 1:6.5 to about 1:23.5, from about 1:7 to about 1:23, or from about 1:7.5 to about 1:22.5.

In some embodiments, the dispersant component is present in a seed treatment mixture comprising the aqueous nematicidal composition in an amount sufficient to reduce crystal formation on the surface of a treated seed under ambient conditions by at least about 10%, at least about 20%, at least about 30%, at least about 40%, at least about 50% at least about 60%, at least about 70%, at least about 80%, or at least about 90% or more.

In some embodiments the aqueous nematicidal composition comprises a dispersed solid particulate phase comprising 3-phenyl-5-(thiophen-2-yl)-1,2,4-oxadiazole, the dispersant package comprising a polyarylphenol alkoxylate or salt thereof selected from the group consisting of phosphate triethanolamine, tristyrylphenol ethoxylate, ethoxylated tristyrylphenol phosphate, polyarylphenylether sulphate, naphthalene sulfonate and the ammonium, potassium, sodium, trimethylamine, or triethylamine salts thereof, and a second dispersant selected from the group consisting of kraft lignin, sodium lignosulfonate, polyvinyl pyrrolidone, copovidone, composite polyvinyl pyrrolidone (PVP) and methyl vinyl ether/maleic acid half ester, co-polymer of metacic acid and olefin, ethylene oxide/propylene oxide block copolymer, and non-ionic acrylic copolymer.

Additional Composition Components

In addition to the 3,5-disubstituted-1,2,4-oxadiazole compound or a salt thereof and a dispersant component comprising a polyarylphenol alkoxylate and a second dispersant, the aqueous nematicidal composition may optionally contain additional components such as an antifreeze agent(s), thickener(s), antifoam agent(s), etc.

Antifreeze Agents

In some embodiments, the composition may further comprise one or more antifreeze agents. In one embodiment, the antifreeze agent is an alcohol. Non-limiting examples of antifreeze agents include ethylene glycol, propylene glycol, butanediol, pentanediol, mannitol, sorbitol, and glycerol (glycerin).

The composition may comprise the antifreeze agent in a concentration of at least about 0.5 wt %, at least about 1 wt %, at least about 2 wt %, at least about 3 wt %, at least about 4 wt %, or at least about 5 wt %. The antifreeze agent is typically present in a concentration of from about 0.5 wt % to about 10 wt %, from about 1 wt % to about 9 wt %, from about 2 wt % to about 8 wt %, from about 3 wt % to about 7 wt %, or from about 4 wt % to about 6 wt %.

Thickener

In some embodiments, the composition may comprise a thickener (referred to hereinafter as a “stabilizer component”). Examples of stabilizers include anionic polysaccharides and cellulose derivatives. In some embodiments, the stabilizer comprises a clay or a silica, or a colloidal hydrophilic silica. Non-limiting examples of commercially available stabilizers include KELZAN CC or KELZAN S PLUS (available from Kelco), methyl cellulose, carboxymethylcellulose and 2-hydroxyethylcellulose, hydroxypropyl-methylcellulose, hydroxymethylcellulose, kaolin, microcrystalline cellulose, and xanthan gum. A non-limiting example of a commercially available colloidal hydrophilic silica is AEROSIL (available from Evonik).

The stabilizer component typically comprises from about 0.05% to about 10% by weight of the composition. For example, in some embodiments, the stabilizer component comprises from about 0.1 wt % to about 5 wt %, from about 0.1 wt % to about 2 wt %, from about 0.1 wt % to about 1 wt %, from about 0.1 wt % to about 0.5 wt %, from about 0.1 wt % to about 0.25 wt %, or from about 0.05 wt % to about 0.2 wt % of the composition.

Antifoam Agents

In some embodiments, the composition may further comprise one or more antifoam agents. Examples of antifoam agents include organosilicone or silicone-free compounds. Non-limiting examples of commercially available antifoam agents include BREAK-THRU OE441 (available from Evonik), BREAK-THRU AF9905 (available from Evonik), AGNIQUE DF 6889 (available from Cognis), AGNIQUE DFM 111S (available from Cognis), BYK-016 (available from BYK), FG-10 antifoam emulsion (available from Dow Corning), 1520-US (available from Dow Corning), 1510-US (available from Dow Corning), SAG 1538 (available from Momentive), and SAG 1572 (available from Momentive).

The antifoam agent typically comprises from about 0.05 wt % to about 10 wt % of the composition. For example, in some embodiments, the antifoam agent comprises from about 0.1 wt % to about 5 wt %, from about 0.1 wt % to about 2 wt %, from about 0.25 wt % to about 1 wt %, or from about 0.5 wt % to about 1 wt % of the composition.

Further Components

In addition to the above optional components, various additional adjuvants may optionally be utilized in the aqueous nematicidal composition described herein. For example, and without limitation, the composition may further comprise dendrimers, buffers, one or more solvents, biocidal agents, rheology modifying agents, and/or wetting agents. Discussion of these optional components as well as non-limiting commercially available examples of such components can be found in U.S. Patent Application Publication Nos. 2014/0187419 A1 and 2015/0342189 A1, the contents of which are expressly incorporated herein by reference.

Additional Agrochemical Ingredients

The compositions described herein may comprise a plurality of agrochemicals in combination with the 3,5-disubstituted-1,2,4-oxadiazole compounds described herein. Non-limiting examples of agrochemicals that may be present in the compositions, for example, in the form of a suspension concentrate are described in detail below.

The compositions in some embodiments may further comprise one or more pesticidal agents. Pesticidal agents include chemical pesticides and biopesticides or biocontrol agents. Various types of chemical pesticides and biopesticides include acaricides, insecticides, nematicides, fungicides, gastropodicides, herbicides, virucides, bactericides, and combinations thereof. Biopesticides or biocontrol agents may include bacteria, fungi, beneficial nematodes, and viruses that exhibit pesticidal activity. Compositions may comprise other agents for pest control, such as microbial extracts and/or plant defense agents.

In some embodiments, the composition comprises 3-phenyl-5-(thiophen-2-yl)-1,2,4-oxadiazole of Formula Ia-i and one or more pesticidal agents. Pesticidal agents include chemical pesticides and biopesticides or biocontrol agents. Various types of chemical pesticides and biopesticides include acaricides, insecticides, nematicides, fungicides, gastropodicides, herbicides, virucides, bactericides, and combinations thereof. Biopesticides or biocontrol agents may include bacteria, fungi, beneficial nematodes, and viruses that exhibit pesticidal activity. Compositions comprising 3-phenyl-5-(thiophen-2-yl)-1,2,4-oxadiazole of Formula Ia-i may comprise other agents for pest control, such as microbial extracts and/or plant defense agents.

Acaricides. Insecticides and/or Nematicides

In some embodiments, the composition comprises one or more chemical acaricides, insecticides, and/or nematicides. Non-limiting examples of chemical acaricides, insecticides, and/or nematicides may include one or more carbamates, diamides, macrocyclic lactones, neonicotinoids, organophosphates, phenylpyrazoles, pyrethrins, spinosyns, synthetic pyrethroids, tetronic acids and/or tetramic acids. Non-limiting examples of chemical acaricides, insecticides and nematicides that can be useful in compositions of the present disclosure include abamectin, acrinathrin, aldicarb, aldoxycarb, alpha-cypermethrin, betacyfluthrin, bifenthrin, cyhalothrin, cypermethrin, deltamethrin, esfenvalerate, etofenprox, fenpropathrin, fenvalerate, flucythrinate, fosthiazate, lambda-cyhalothrin, gamma-cyhalothrin, permethrin, tau-fluvalinate, transfluthrin, zeta-cypermethrin, cyfluthrin, tefluthrin, eflusilanat, fubfenprox, pyrethrin, resmethrin, imidacloprid, acetamiprid, thiamethoxam, nitenpyram, thiacloprid, dinotefuran, clothianidin, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (e.g., Rynaxypjr), cyazypyr, emamectin, emamectin benzoate, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, 3,5-disubstituted-1,2,4-oxadiazole compounds, 3-phenyl-5-(thien-2-yl)-1,2,4-oxadiazole, cadusaphos, carbaryl, carbofuran, ethoprophos, thiodicarb, metamidophos, methiocarb, sulfoxaflor, methamidophos, cyantraniliprole and tioxazafen and combinations thereof. Certain non-limiting examples of chemical acaricides, insecticides, and/or nematicides may include one or more of abamectin, aldicarb, aldoxycarb, bifenthrin, carbofuran, chlorantraniliporle, chlothianidin, cyfluthrin, cyhalothrin, cypermethrin, cyantraniliprole, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, spinetoram, spinosad, spirodichlofen, spirotetramat, tefluthrin, thiacloprid, thiamethoxam, tioxazafen and/or thiodicarb, and combinations thereof.

In some embodiments, the composition comprises 3-phenyl-5-(thiophen-2-yl)-1,2,4-oxadiazole of Formula Ia-i and one or more chemical acaricides, insecticides, and/or nematicides. Non-limiting examples of chemical acaricides, insecticides, and/or nematicides may include one or more insecticide and/or nematicide selected from the group (IRAC classification groups) consisting of:

(1) Acetlcholinesterase (AChE) inhibitors, such as, for example, carbamates and organophosphates. Non-limiting examples of carbamates include alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xvlylcarb. Non-limiting examples of organophosphates include acephate, azamethiphos, azinphos-ethyl, azinphos-methyl, cadusafos, chlorethoxyfos, chlorfenvinphos, chlormephos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion;

(2) GABA-gated chloride channel blockers, such as, for example, cyclodiene-organochlorines and phenylpyrazoles (fiproles). Non-limiting examples of cyclodiene-organochlorines include chlordane and endosulfan. Non-limiting examples of phenylpyrazoles (fiproles) include ethiprole and fipronil;

(3) Sodium channel modulators, such as, for example, pyrethroids, pyrethrins (pyrethum), DDT, and methoxychlor. Non-limiting examples include acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans-isomer], prallethrin, resmethrin, silafluofen, tefluthrin, tetramethrin, tetramethrin [(1R)-isomer)], tralomethrin and transfluthrin;

(4) Nicotinic acetylcholine receptor (nAChR) competitive modulators, such as, for example, neonicotinoids, nicotine, sulfoxaflor, and flupyradifurone. Non-limiting examples of neonicotinoids include acetamiprid, clothianidin, dinotefuran, imidacloprid, nitenpyram, thiacloprid and thiamethoxam;

(5) Nicotinic acetylcholine receptor (nAChR) allosteric modulators, such as, for example, spinosyns, e.g. spinetoram and spinosad;

(6) Glutamate-gated chloride channel (GluCl) allosteric modulators, such as, for example, avermectins and milbemycins. Non-limiting examples of avermectins and milbemrncins include abamectin, emamectin benzoate, lepimectin and milbemectin;

(7) Juvenile hormone mimics, such as, for example, juvenile hormone analogues, fenoxycarb, and pyriproxyfen. Non-limiting examples of juvenile hormone analogues include hydroprene, kinoprene and methoprene:

(8) Miscellaneous non-specific (multi-site) inhibitors, such as, for example, alkyl halides (e.g., methyl bromide), chloropicrine, sulphuryl fluoride, borax, tartar emetic, or methyl isocyanate generators. Non-limiting examples of methyl isocyanate generators include dazomet and metam;

(9) Chordotonal organ TRPV channel modulators, such as, for example pymetrozine and pyrifluquinazone:

(10) Mite growth inhibitors, such as, for example clofentezine, hexythiazox, diflovidazin and etoxazole;

(11) Microbial disruptors of the insect gut membrane, such as, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins: Cry1Ab, Cry1Ac, Cry1Fa, Cry1A.105, Cri2Ab, Vip3A, mCry3A, Cry3Ab, Cry3Bb and Cry34Ab1/35Ab1:

(12) Inhibitors of mitochondrial ATP synthase, such as ATP disruptors, non-limiting examples of which include diafenthiuron, organotin compounds, propargite and tetradifon. Non-limiting examples of organotin compounds include azocyclotin, cyhexatin, and fenbutatin oxide:

(13) Uncouplers of oxidative phosphorylation via disruption of the proton gradient, such as, for example, chlorfenapyr, DNOC and sulfluramid;

(14) Nicotinic acetylcholine receptor channel blockers, such as, for example, bensultap, cartap hydrochloride, thiocylam and thiosultap-sodium;

(15) Inhibitors of chitin biosynthesis, type 0, such as, for example, bistrifluron, chlorfluazuron, diflubenzuron, flucycloxuron, flufenoxuron, hexaflumuron, lufenuron, novaluron, noviflumuron, tellubenzuron and triflumuron;

(16) Inhibitors of chitin biosynthesis, type 1, for example buprofezin:

(17) Moulting disruptor (in particular for Diptera. i.e. dipterans), such as, for example, cyromazine;

(18) Ecdysone receptor agonists, such as, for example, chromafenozide, halofenozide, methoxyfenozide and tebufenozide;

(19) Octopamine receptor agonists, such as, for example, amitraz;

(20) Mitochondrial complex III electron transport inhibitors, such as, for example, hydramethylnone, acequinocyl and fluacrypyrim:

(21) Mitochondrial complex I electron transport inhibitors, such as, for example METI acaricides or rotenone (Derris). Non-limiting examples of METI acaricides include fenazaquin, fenpyroximate, pyrimidifen, pyridaben, tebufenpyrad and tolfenpyrad;

(22) Voltage-dependent sodium channel blockers, such as, for example indoxacarb and metaflumizone;

(23) Inhibitors of acetyl CoA carboxylase, such as, for example, tetronic and tetramic acid derivatives such as spirodiclofen, spiromesifen and spirotetramat;

(24) Mitochondrial complex IV electron transport inhibitors, such as, for example, phosphides or cyanides. Non-limiting examples of phosphides include aluminium phosphide, calcium phosphide, phosphine and zinc phosphide. Non-limiting examples of cyanides include calcium cyanide, potassium cyanide and sodium cyanide;

(25) Mitochondrial complex II electron transport inhibitors, such as, for example, beta-ketonitrile derivatives and carboxanilides. Non-limiting examples of beta-ketonitrile derivatives include cyenopyrafen and cyflumetofen. A non-limiting example of carboxanilides includes pyflubumide:

(28) Ryanodine receptor modulators, such as, for example, diamides. Non-limiting examples of diamides include chlorantraniliprole, cyantraniliprole and flubendiamide;

(29) Chordotonal organ modulators (with undefined target site) such as, for example, flonicamid:

(30) further active compounds selected from acynonapyr, afidopyropen, afoxolaner, azadirachtin, benclothiaz, benzoximate, benzpyrimoxane, bifenazate, broflanilide, bromopropylate, chinomethionat, chloroprallethrin, crvolite, cyclaniliprole, cycloxaprid, cyhalodiamide, dicloromezotiaz, dicofol, epsilon-metofluthrin, epsilon-momfluthrin, flometoquin, fluazaindolizine, fluensulfone, flufenerim, flufenoxystrobin, flufiprole, fluhexafon, fluopyram, flupyrimine, fluralaner, fluxametamide, fufenozide, guadipyr, heptafluthrin, imidaclothiz, iprodione, kappa-bifenthrin, kappa-tefluthrin, lotilaner, meperfluthrin, oxazosulfyl, paichongding, pyridalyl, pyrifluquinazon, pyriminostrobin, spirobudiclofen, spiropidione, tetramethylfluthrin, tetraniliprole, tetrachlorantraniliprole, tigolaner, thiofluoximate, triflumezopyrim and iodomethane; preparations based on Bacillus firmus (1-1582, BioNeem, Votivo); and the following compounds: 1-{2-fluoro-4-methyl-5-[(2,2,2-trifluoroethyl)sulphinyl]phenyl}-3-(trifluoromethyl)-1H-1,2,4-triazole-5-amine (known from WO2006/043635) (CAS 885026-50-6), {1′-[(2E)-3-(4-chlorophenyl)prop-2-en-1-yl]-5-fluorospiro[indol-3,4′-piperidin]-1(2H)-yl}(2-chloropyridin-4-yl)methanone (known from WO2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494) (CAS 872999-66-1), 3-(4-chloro-2,6-dimethylphenyl)-4-hydroxy-8-methoxy-1,8-diazaspiro[4.5]dec-3-en-2-one (known from WO 2010052161) (CAS 1225292-17-0), 3-(4-chloro-2,6-dimethylphenyl)-8-methoxy-2-oxo-1,8-diazaspiro[4.5]dec-3-en-4-yl ethyl carbonate (known from EP2647626) (CAS 1440516-42-6), 4-(but-2-yn-1-yloxy)-6-(3,5-dimethylpiperidin-1-yl)-5-fluoropyrimidine (known from WO2004/099160) (CAS 792914-58-0), PF1364 (known from JP2010/018586) (CAS 1204776-60-2), (3E)-3-[1-[(6-chloro-3-pyridyl)methyl]-2-pyridylidene]-1,1,1-trifluoro-propan-2-one (known from WO2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN103232431) (CAS 1449220-44-3). 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7). N-[3-chloro-1-(3-pyridinyl)-1H-pyrazol-4-yl]-N-ethyl-3-[(3,3,3-trifluoropropyl)sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-1 (3,3,3-trifluoropropyl)sulfinyl I-propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A) (CAS 1232543-85-9); N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide (known from WO 2012/034403 A1) (CAS 1268277-22-0), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4-[3-[2,6-dichloro-4-[(3,3-dichloro-2-propen-1-yl)oxy]phenoxy]propoxy]-2-methoxy-6-(trifluoromethyl)-pyrimidine (known from CN 101337940 A) (CAS 1108184-52-6); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A) (CAS 1232543-85-9); 3-(2,2-dichloroethenyl)-2,2-dimethyl-4-(1H-benzimidazol-2-yl)phenyl-cyclopropanecarboxylic acid ester (known from CN 103524422 A) (CAS 1542271-46-4); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester (known from CN 102391261 A) (CAS 1370358-69-2); 6-deoxy-3-O-ethyl-2,4-di-O-methyl-, 1-[N-[4-[1-[4-(1,1,2,2,2-pentafluoroethoxy)phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethyl-phenoxy)-3-(6-trifluoromethyl-pyridazin-3-yl)-3-aza-bicyclo[3.2.1]octane (CAS 1253850-56-4), (8-anti)-8-(2-cyclopropylmethoxy-4-trifluoromethyl-phenoxy)-3-(6-trifluoromethyl-pyridazin-3-yl)-3-aza-bicyclo[3.2.1]octane (CAS 933798-27-7), (8-syn)-8-(2-cyclopropylmethoxy-4-trifluoromethyl-phenoxy)-3-(6-trifluoromethyl-pyridazin-3-yl)-3-aza-bicyclo[3.2.1]octane (known from WO 2007040280 A1. WO 2007040282 A1) (CAS 934001-66-8). N-[3-chloro-1-(3-pyridinyl)-1H-pyrazol-4-yl]-N-ethyl-3-[(3,3,3-trifluoropropyl)thio]-propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7). 5-(1,3-dioxan-2-yl)-4-[[4-(trifluoromethyl)phenyl]methoxy]-pyrimidine (known from WO 2013/115391 A1) (CAS 1449021-97-9), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), 3-(4-chloro-2,6-dimethylphenyl)-8-methoxy-1-methyl-2-oxo-1,8-diazaspiro[4.5]dec-3-en-4-yl-carbonic acid ethyl ester (known from WO 2010/066780 A1, WO 2011151146 A1) (CAS 1229023-00-0) and 4-[(5S)-5-(3,5-Dichlor-4-fluorophenyl)-4,5-dihydro-5-(trifluoromethyl)-3-isoxazolyl]-N-[(4R)-2-ethyl-3-oxo-4-isoxazolidinyl]-2-methyl-benzamid (known from WO 2011/067272, WO2013/050302) (CAS 1309959-62-3); and

(31) nematicides selected from abamectin, avermectin, imicyafos, pyrifluquinazon, momfluorothrin, pyflubumide, fluazaindolizine, fosthiazate, fluensulfone, aldicarb, carbofuran, oxamyl, carbosulfan, cloethocarb, thiodicarb, fenamiphos, ethoprophos, terbufos, isazofos, pyraclofos, cadusafos, chlorethoxyfos, fosthiazate, chlorpyriphos-methyL, benzisothiazole, fumigants, Bacillus firmus, Bacillus firmus I-1582, β-cyfluthrin, transfluthrin and flonicamid.

Additional non-limiting examples of acaricides, insecticides and nematicides that may be included or used in compositions in some embodiments may be found in Steffey and Gray, Managing Insect Pests, ILLINOIS AGRONOMY HANDBOOK (2008); and Niblack, Nematodes, ILLINOIS AGRONOMY HANDBOOK (2008), the contents and disclosures of which are incorporated herein by reference. Non-limiting examples of commercial insecticides which may be suitable for the compositions disclosed herein include CRUISER (Syngenta, Wilmington, Del.), GAUCHO and PONCHO (Gustafson. Piano, Tex.). Active ingredients in these and other commercial insecticides may include thiamethoxam, clothianidin, and imidacloprid. Commercial acaricides, insecticides, and/or nematicides may be used in accordance with a manufacturer's recommended amounts or concentrations.

In some embodiments, the composition comprises one or more biopesticidal agents the presence and/or output of which is toxic to an acarid, insect and/or nematode. For example, the composition may comprise one or more of Bacillus firmus 1-1582, Bacillus mycoides AQ726, NRRL B-21664; Beauveria bassiana ATCC-74040, Beauveria bassiana ATCC-74250, Burkholderia sp. A396 sp. nov. rinojensis, NRRL B-50319, Chromobacterium subtsugae NRRL B-30655. Chromobacterium vaccinii NRRL B-50880, Flavobacterium H492, NRRL B-50584, Metarhizium anisopliae F52 (also known as Metarhizium anisopliae strain 52, Metarhizium animsopliae strain 7, Metarhizium anisopliae strain 43, and/or Metarhizium anisopliae BIO-1020, TAE-001; deposited as DSM 3884, DSM 3885, ATCC 90448, SD 170 and ARSEF 7711), Paecilomyces fumosoroseus FE991, and combinations thereof.

Fungicides

In some embodiments, the composition comprises one or more chemical fungicides. Non-limiting examples of chemical fungicides may include one or more aromatic hydrocarbons, benzthiadiazole, carboxylic acid amides, morpholines, phenylamides, phosphonates, thiazolidines, thiophene, quinone outside inhibitors and strobilurins, such as azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester, and 2-(2-(3-(2,6-dichlorophenyl)-1-methyl-allylideneaminooxymethyl)-phenyl)-2-methoxyimino-N-methyl-acetamide, carboxamides, such as carboxanilides (e.g., benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyrazole-4-carboxamide, N-(2-(1,3,3-trimethylbutyl)-phenyl)-1,3-dimethyl-5-fluoro-1H-pyrazole-4-carboxamide), carboxylic morpholides (e.g., dimethomorph, flumorph, pyrimorph), benzoic acid amides (e.g., flumetover, fluopicolide, fluopyram, zoxamide), carpropamid, dicyclomet, mandiproamid, fenehexamid, oxytetracyclin, silthiofam, and N-(6-methoxy-pyridin-3-yl) cyclopropanecarboxylic acid amide, spiroxamine, azoles, such as triazoles (e.g., azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole) and imidazoles (e.g., cyazofamid, imazalil, pefurazoate, prochloraz, triflumizol); heterocyclic compounds, such as pyridines (e.g., fluazinam, pyrifenox (cfD1b), 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine), pyrimidines (e.g., bupirimate, cyprodinil, diflumetorim, fenarimol, ferimzone, mepanipyrim, nitrapyrin, nuarimol, pyrimethanil), piperazines (e.g., triforine), pyrroles (e.g., fenpiclonil, fludioxonil), morpholines (e.g., aldimorph, dodemorph, dodemorph-acetate, fenpropimorph, tridemorph), piperidines (e.g., fenpropidin); dicarboximides (e.g., fluoroimid, iprodione, procymidone, vinclozolin), non-aromatic 5-membered heterocycles (e.g., famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester), acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine; benzimidazoles, such as carbendazim; and other active substances, such as guanidines (e.g., guanidine, dodine, dodine free base, guazatine, guazatine-acetate, iminoctadine), iminoctadine-triacetate and iminoctadine-tris(albesilate); antibiotics (e.g., kasugamycin, kasugamycin hydrochloride-hydrate, streptomycin, polyoxine and validamycin A), nitrophenyl derivates (e.g., binapacryl, dicloran, dinobuton, dinocap, nitrothal-isopropyl, tecnazen), organometal compounds (e.g., fentin salts, such as fentin-acetate, fentin chloride, fentin hydroxide); sulfur-containing heterocyclyl compounds (e.g., dithianon, isoprothiolane), organophosphorus compounds (e.g., edifenphos, fosetyl, iprobenfos, phosphorus acid and its salts, pyrazophos, tolclofos-methyl), organochlorine compounds (e.g., chlorothalonil, dichlofluanid, dichlorophen, flusulfamide, hexachlorobenzene, pencycuron, pentachlorphenole and its salts, phthalide, quintozene, thiophanate-methyl, thiophanates, tolylfluanid, N-(4-chloro-2-nitro-phenyl)-N-ethyl-4-methyl-benzenesulfonamide) and inorganic active substances (e.g., Bordeaux mixture, copper acetate, copper hydroxide, copper oxychloride, basic copper sulfate, sulfur) and combinations thereof. In an aspect, the compositions in some embodiments comprise acibenzolar-S-methyl, azoxystrobin, benalaxyl, bixafen, boscalid, carbendazim, cyproconazole, dimethomorph, epoxiconazole, fludioxonil, fluopyram, fluoxastrobin, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thiabendazole, thifluzamide, thiophanate, tolclofos-methyl, trifloxystrobin and triticonazole, and combinations thereof.

In some embodiments, compositions comprising 3-phenyl-5-(thiophen-2-yl)-1,2,4-oxadiazole of Formula Ia-i further comprise one or more chemical fungicides. Non-limiting examples of chemical fungicides may include fungicides selected from;

(1) the group of inhibitors of the ergosterol synthesis selected from the group consisting of (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole. (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)-cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxyl)phenyl]-4-methyl-1,3-dioxolan-2-yl}methyl)-1H-1,2,4-triazole. (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione. (1.043) 2-[(2R,4R,5S)-1-(2,4-dichlorophenyl)-5-hydroxy-2,6,6-trimethylheptan-4-yl]-2,4-dihydro-3H-1,2,4-triaole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylbeptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylbeptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione. (1.050) 2-[1-(2,4-dichlorophenyl)-5-hydroxy-2,6,6-trimethyliheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol. (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) 2-[4-(4-chlorophenoxy)-2-(trifluoromethyl)phenyl]-1-(1H-1,2,4-triazol-1-yl)propan-2-ol, (1.056) 2-{[3-(2-chlorophenyl)-2-(2,4-difluorophenyl)oxiran-2-yl]methyl}-2,4-dihydro-3H-1,2,4-triazole-3-thione. (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl)}-1H-1,2,4-triazole, (1.061) 5-(allylsulfanyl)-1-{[rel(2R,3R)-3-(2-chlorophenyl)-2-(2,4-difluoropbenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide. (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Mefentrifluconazole, (1.082), and Ipfentrifluconazole;

(2) inhibitors of the respiratory chain at complex I or II selected from the group consisting of (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr. (2.009) Isofetamid, (2.010) isopyrazam (anti-epimeric enantiomer 1R,4S,9S), (2.011) isopyrazam (anti-epimeric enantiomer 1 S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS). (2.017) penflufen. (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamiide, (2.024) 1,3-dimethyl-N-[(3S)-1,1,3-trimethyl-2,3-dihydro-1H-inden-4-yl]1H-pyrazole-4-carboxamide, (2.025) 1-methyl-3-(trifluoromethyl)-N-[2′-(trifluoromethyl)biphenyl-2-yl]-1H-pyrazole-4-carboxamide. (2.026) 2-fluoro-6-(trifluoromethyl)-N-(1,1,3-trimethyl-2,3-dihydro-1H-inden-4-yl)benzamide. (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) 3-(difluoromethyl)-N-(7-fluoro-1,1,3-trimethyl-2,3-dihydro-1H-inden-4-yl)-1-methyl-1H-pyrazole-4-carboxamide, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide. (2.037) N-(5-chloro-2-ethylbenzyl)-N-cyclopropyl-3-(difluoromethyl)-5-fluoro-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamiide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide. (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide. (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, and (2.056) N-cyclopropyl-N-(2-cyclopropylbenzyl)-3-(difluoromethyl)-5-fluoro-1-methyl-1H-pyrazole-4-carboxamide;

(3) inhibitors of the respiratory chain at complex III selected from the group consisting of (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, and (3.029) methyl {5-[3-(2,4-dimethylphenyl)-1H-pyrazol-1-yl]-2-methylbenzyl)}carbamate, (3.030) (1S)-2,2-bis(4-fluorophenyl)-1-methylethyl N-{[3-(acetyloxy)-4-methoxy-2-pyridyl]carbonyl}-L-alaninate:

(4) inhibitors of the mitosis and cell division selected from the group consisting of (4.001) carbendazim. (4.002) diethofencarb, (4.003) ethaboxam, (4.004) fluopicolide, (4.005) pencycuron, (4.006) thiabendazole. (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-H-pyrazol-5-amine, (4.024) N-(2-bromophenyl)-4-(2-chloro-4-fluorophenyl)-1,3-dimethyl-1H-pyrazol-5-amine, and (4.025) N-(4-chloro-2,6-difluorophenyl)-4-(2-chloro-4-fluorophenyl)-1,3-dimethyl-1H-pyrazol-5-amine;

(5) compounds capable of having a multisite action selected from the group consisting of (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, and (5.023) 6-ethyl-5,7-dioxo-6,7-dihydro-5H-pyrrolo[3′,4′:5,6][1,4]dithiino[2,3-c][1,2]thiazole-3-carbonitrile:

(6) compounds capable of inducing a host defense selected from the group consisting of (6.001) acibenzolar-S-methyl, (6.002) isotianil, (6.003) probenazole, and (6.004) tiadinil:

(7) inhibitors of the amino acid and/or protein biosynthesis selected from the group consisting of (7.001) cyprodinil, (7.002) kasugamycin, (7.003) kasugamycin hydrochloride hydrate, (7.004) oxytetracycline, (7.005) pyrimethanil, and (7.006) 3-(5-fluoro-3,3,4,4-tetramethyl-3,4-dihydroisoquinolin-1-yl)quinolone;

(8) inhibitors of the ATP production selected from the group consisting of (8.001) silthiofam;

(9) inhibitors of the cell wall synthesis selected from the group consisting of (9.001) benthiavalicarb. (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, and (9.009) (2Z)-3-(4-tert-butylphenyl)-3-(2-chloropyridin-4-yl)-1-(morpholin-4-yl)prop-2-en-1-one:

(10) inhibitors of the lipid and membrane synthesis selected from the group consisting of (10.001) propamocarb. (10.002) propamocarb hydrochloride, and (10.003) tolclofos-methyl:

(11) inhibitors of the melanine biosynthesis selected from the group consisting of (11.001) tricyclazole, and (11.002) 2,2,2-trifluoroethyl {3-methyl-1-[(4-methylbenzoyl)amino]butan-2-yl}carbamate;

(12) inhibitors of the nucleic acid synthesis selected from the group consisting of (12.001) benalaxyl, (12.002) benalaxyl-M (kiralaxyl), (12.003) metalaxyl, and (12.004) metalaxyl-M (mefenoxam);

(13) inhibitors of the signal transduction selected from the group consisting of (13.001) fludioxonil, (13.002) iprodione, (13.003) procymidone, (13.004) proquinazid, (13.005) quinoxyfen, and (13.006) vinclozolin:

(14) compounds capable of acting as uncoupler selected from the group consisting of (14.001) fluazinam, and (14.002) meptyldinocap; and

(15) other fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid. (15.009) cymoxanil, (15.010) cyprosulfamide, (15.011) flutianil, (15.012) fosetyl-aluminium. (15.013) fosetyl-calcium. (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-(4-[(5R)-5-(2,6-difluorophenyl)-4,5-dihydro-1,2-oxazol-3-yl]-1,3-thiazol-2-yl piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) 2,6-dimethyl-1H,5H-[1,4]dithiino[2,3-c:5,6-c′]dipyrrole-1,3,5,7(2H,6H)-tetrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) 2-{2-[(7,8-difluoro-2-methylquinolin-3-yl)oxy]-6-fluorophenyl}propan-2-ol, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts. (15.046) 3-(4,4,5-trifluoro-3,3-dimethyl-3,4-dihydroisoquinolin-1-yl)quinoline, (15.047) 3-(4,4-difluoro-3,3-dimethyl-3,4-dihydroisoquinolin-1-yl)quinoline, (15.048) 4-amino-5-fluoropyrimidin-2-ol (tautomeric form: 4-amino-5-fluoropyrimidin-2(1H)-one). (15.049) 4-oxo-4-[(2-phenylethyl)amino]butanoic acid, (15.050) 5-amino-1,3,4-thiadiazole-2-thiol. (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl 1-3,4-dihydropyrimidin-2(1H)-one, (15.063) Metyltetraprole, (15.064) Aminopyrifen, (15.065) Pyrapropoyne, (15.068) (2-{2-[(7,8-difluoro-2-methylquinolin-3-yl)oxy]-6-fluorophenyl}propan-2-ol), (15.069) (5-bromo-1-(5,6-dimethylpyridin-3-yl)-3,3-dimethyl-3,4-dihydroisoquinoline), (15.070) (3-(4,4-difluoro-5,5-dimethyl-4,5-dihydrothieno[2,3-c]pyridin-7-yl)quinoline). (15.071) (1-(4,5-dimethyl-1H-benzimidazol-1-yl)-4,4-difluoro-3,3-dimethyl-3,4-dihydroisoquinoline), (15.072) 8-fluoro-3-(5-fluoro-3,3-dimethyl-3,4-dihydroisoquinolin-1-yl)quinolone, (15.073) 8-fluoro-3-(5-fluoro-3,3,4,4-tetramethyl-3,4-dihydroisoquinolin-1-yl)quinolone, (15.074) 3-(4,4-difluoro-3,3-dimeth)yl-3,4-dihydroisoquinolin-1-yl)-8-fluoroquinoline, (15.075) (N-methyl-N-phenyl-4-[5-(trifluoromethyl)-1,2,4-oxadiazol-3-yl]benzaznide), (15.076) (methyl {4-[5-(trifluoromethyl)-1,2,4-oxadiazol-3-yl]phenyl}carbamate), (15.077) (N-[4-[5-(trifluoromethyl)-1,2,4-oxadiazol-3-yl]benzyl)cyclopropanecarboxamide). (15.078) N-methyl-4-(5-(trifluoromethyl)-1,2,4-oxadiazol-3-yl]benzamide, (15.079) N-[(E)-methoxyiminomethyl]-4-[5-(trifluoromethyl)-1,2,4-oxadiazol-3-yl]benzaznide, (15.080) N—[(Z)-methoxyiminomethyl]-4-[5-(trifluoromethyl)-1,2,4-oxadiazol-3-yl]benzamide, (15.081) N-[4-[5-(trifluoromethyl)-1,2,4-oxadiazol-3-yl]phenyl]cyclopropanecarboxamide, (15.082) N-(2-fluorophenyl)-4-[5-(trifluoromethyl)-1,2,4-oxadiazol-3-yl]benzamide, (15.083) 2,2-difluoro-N-methyl-2-[4-[5-(trifluoromethyl)-1,2,4-oxadiazol-3-yl]phenyl]acetamide, (15.084) N-allyl-N-[[4-[5-(trifluoromethyl)-1,2,4-oxadiazol-3-yl)phenyl]methyl]acetamide, (15.085) N-[(E)-N-methoxy-C-methyl-carbonimidoyl]-4-(5-(trifluoromethyl)-1,2,4-oxadiazol-3-yl]benzamide, (15.086) N—[(Z)—N-methoxy-C-methyl-carbonimidoyl]-4-[5-(trifluoromethyl)-1,2,4-oxadiazol-3-yl]benzamide, (15.087) N-allyl-N-[[4-[5-(trifluoromethyl)-1,2,4-oxadiazol-3-yl]phenyl]methyl]propanamide, (15.088) 4,4-dimethyl-1-[[4-[5-(trifluoromethyl)-1,2,4-oxadiazol-3-yl]phenyl]methyl]pyrrolidin-2-one, (15.089) N-methyl-4-[5-(trifluoromethyl)-1,2,4-oxadiazol-3-yl]benzenecarbothioamide, (15.090) 5-methyl-1-[[4-[5-(trifluoromethyl)-1,2,4-oxadiazol-3-yl]phenyl]methyl]pyrrolidin-2-one, (15.091) N-((2,3-difluoro-4-[5-(trifluoromethyl)-1,2,4-oxadiazol-3-yl]phenyl]methyl]-3,3,3-trifluoro-propanamide, (15.092) 1-methoxy-1-methyl-3-[[4-[5-(trifluoromethyl)-1,2,4-oxadiazol-3-yl]phenyl]methyl]urea, (15.093) 1,1-diethyl-3-{[4-[5-(trifluoromethyl}-1,2,4-oxadiazol-3-yl]phenyl]methyl]urea, (15.094) N-[[4-[5-(trifluoromethyl)-1,2,4-oxadiazol-3-yl]phenyl)methyl)propanamide, (15.095) N-methoxy-N-[[4-[5-(trifluoromethyl)-1,2,4-oxadiazol-3-yl]phenyl]methyl]cyclopropanecarboxamide, (15.096) 1-methoxy-3-methyl-1-[[4-[5-(trifluoromethyl)-1,2,4-oxadiazol-3-yl]phenyl]methyl]urea, (15.097) N-methoxy-N-[[4-[5-(trifluoromethyl)-1,2,4-oxadiazol-3-yl]phenyl]methyl)cyclopropanecarboxamide; (15.098) N,2-dimethoxy-N-[[4-[5-(trifluoromethyl)-1,2,4-oxadiazol-3-yl]phenyl]methyl]propanamide, (15.099) N-ethyl-2-methyl-N-[[4-[5-(trifluoromethyl)-1,2,4-oxadiazol-3-yl)phenyl]methyl]propanamide, (15.100) 1-methoxy-3-methyl-1-[[4-[5-(trifluoromethyl)-1,2,4-oxadiazol-3-yl]phenyl]methyl]urea, (15.101) 1,3-dimethoxy-1-[[4-[5-(trifluoromethyl)-1,2,4-oxadiazol-3-yl]phenyl]methyl]urea, (15.102) 3-ethyl-1-methoxy-1-[[4-[5-(trifluoromethyl)-1,2,4-oxadiazol-3-yl]phenyl]methyl]urea, (15.103) 1-[[4-[5-(trifluoromethyl)-1,2,4-oxadiazol-3-yl]phenyl]methyl]piperidin-2-one (15.104) 4,4-dimethyl-2-[[4-(5-(trifluoromethyl)-1,2,4-oxadiazol-3-yl]phenyl]methyl]isooxazolidin-3-one, (15.105) 5,5-dimethyl-2-[[4-[5-(trifluoromethyl)-1,2,4-oxadiazol-3-yl]phenyl]methyl]isoxazolidin-3-one, (15.106), 3,3-dimethyl-1-[[4-[5-(trifluoromethyl)-1,2,4-oxadiazol-3-yl]phenyl]methyl]piperidin-2-one, (15.107) 1-[[3-fluoro-4-(5-(trifluoromethyl)-1,2,4-oxadiazol-3-yl]phenyl]methyl]azepan-2-one, (15.108) 4,4-dimethyl-2-[[4-(5-(trifluoromethyl)-1,2,4-oxadiazol-3-yl]phenyl]methyl]isoxazolidin-3-one and (15.109) 5,5-dimethyl-2-[[4-[5-(trifluoromethyl)-1,2,4-oxadiazol-3-yl]phenyl]methyl]isoxazolidin-3-one.

For additional examples of fungicides that may be included in the compositions in some embodiments see, e.g., Bradley, Managing Diseases, ILLINOIS AGRONOMY HANDBOOK (2008), the content and disclosure of which are incorporated herein by reference. Fungicides useful for the compositions in some embodiments may exhibit activity against one or more fungal plant pathogens, including but not limited to Phytophthora. Rhizoctonia, Fusarium, Pythium, Phomopsis, Sclerotinia or Phakopsora, and combinations thereof. Non-limiting examples of commercial fungicides which may be suitable for the compositions in some embodiments include PROTÉGÉ, RIVAL or ALLEGIANCE FL or LS (Gustafson, Piano, Tex.), WARDEN RTA (Agriliance, St. Paul, Minn.), APRON XL, APRON MAXX RTA or RFC, MAXIM 4FS or XL (Syngenta, Wilmington, Del.), CAPTAN (Arvesta, Guelph, Ontario) and PROTREAT (Nitragin Argentina. Buenos Ares. Argentina). Active ingredients in these and other commercial fungicides include, but are not limited to, fludioxonil, mefenoxam, azoxystrobin and metalaxyl. Commercial fungicides may be used in accordance with a manufacturer's recommended amounts or concentrations.

In some embodiments, the composition comprises one or more biopesticidal agents the presence and/or output of which is toxic to at least one fungus and/or bacteria. For example, the composition may comprise one or more of Ampelomyces quisqualis AQ 10® (Intrachem Bio GmbH & Co. KG, Germany). Aspergillus flavus AFLA-GUARD® (Syngenta Crop Protection, Inc., CH), Aureobasidium pullulans BOTECTOR-k (bio-ferm GmbH, Germany), Bacillus pumilus AQ717 (NRRL B-21662), Bacillus pumilus NRRL B-30087. Bacillus AQ 175 (ATCC 55608), Bacillus AQ 177 (ATCC 55609), Bacillus subtilis AQ713 (NRRL B-21661), Bacillus subtilis AQ743 (NRRL B-21665), Bacillus amyloliquefaciens FZB24, Bacillus amyloliqueficiens FZB42, Bacillus amyloliquefaciens NRRL B-50349. Bacillus subtilis ATCC 55078, Bacillus subtilis ATCC 55079, Bacillus thuringiensis AQ52 (NRRL B-21619), Candida oleophila 1-182 (e.g., ASPIRE® from Ecogen Inc., USA), Candida saitoana BIOCURE® (in mixture with lysozyme; BASF, USA) and BIOCOAT® (ArystaLife Science, Ltd., Cary, N.C.), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I.A.P.A., Italy) and FUSACLEAN® (Natural Plant Protection, France), Metschnikowia fructicola SHEMER® (Agrogreen, Israel), Microdochium dimerum ANTIBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX®, (Plant Products Co. Ltd., Canada). Pythium oligandrum DV74 (POLYVERSUM®, Remeslo SSRO, Biopreparaty, Czech Rep.), Reynoutria sachlinensis (e.g., REGALIA® from Marrone Biolnnovations, USA). Streptomyces NRRL B-30145, Streptomyces M1064. Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation. USA), Streptomyces WYE 53 (ATCC 55750; DE-THATCH-9®, DECOMP-9® and THATCH CONTROL®, Idaho Research Foundation, USA), Talaromyces flavus V117b (PROTUS®, Prophyta, Germany), Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®, Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E.P.L.A.C., Brazil), Trichoderma virens GL-21 (SOILGARD®, Certis LLC. USA), and combinations thereof.

Herbicides

In some embodiments, the composition comprises one or more suitable chemical herbicides. The herbicides may be a pre-emergent herbicide, a post-emergent herbicide, or a combination thereof. Non-limiting examples of chemical herbicides may comprise one or more acetyl CoA carboxylase (ACCase) inhibitors, acetolactate synthase (ALS) inhibitors, acetanilides, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvylshikimate-3-phosphate (EPSP) synthase inhibitors, glutamine synthetase inhibitors, dihydropteroate synthetase inhibitors, mitosis inhibitors, 4-hydroxyphenyl-pyruvate-dioxygenase (4-HPPD) inhibitors, synthetic auxins, auxin herbicide salts, auxin transport inhibitors, nucleic acid inhibitors and/or one or more salts, esters, racemic mixtures and/or resolved isomers thereof. Non-limiting examples of chemical herbicides that can be useful in compositions of the present disclosure include 2,4-dichlorophenoxyacetic acid (2,4-D), 2,4,5-trichlorophenoxyacetic acid (2,4,5-T), ametryn, amicarbazone, aminocyclopyrachlor, acetochlor, acifluorfen, alachlor, atrazine, azafenidin, bentazon, benzofenap, bifenox, bromacil, bromoxynil, butachlor, butafenacil, butroxydim, carfentrazone-ethyl, chlorimuron, chlorotoluro, clethodim, clodinafop, clomazone, cyanazine, cycloxydim, cyhalofop, desmedipham, desmetryn, dicamba, diclofop, dimefuron, diflufenican, diuron, dithiopyr, ethofumesate, fenoxaprop, foramsulfuron, fluazifop, fluazifop-P, flufenacet, fluometuron, flufenpyr-ethyl, flumiclorac, flumiclorac-pentyl, flumioxazin, fluoroglycofen, fluthiacet-methyl, fomesafen, glyphosate, glufosinate, halosulfuron, haloxyfop, hexazinone, iodosulfuron, indaziflam, imazamox, imazaquin, imazethapyr, ioxynil, isoproturon, isoxaflutole, lactofen, linuron, mecoprop, mecoprop-P, mesosulfuron, mesotrion, metamitron, metazochlor, methibenzuron, metolachlor (and S-metolachlor), metoxuron, metribuzin, monolinuron, oxadiargyl, oxadiazon, oxaziclomefone, oxyfluorfen, phenmedipham, pretilachlor, profoxydim, prometon, prometrn, propachlor, propanil, propaquizafop, propisochlor, propoxycarbazone, pyraflufen-ethyl, pyrazon, pyrazolynate, pyrazoxyfen, pyridate, quizalofop, quizalofop-P (e.g., quizalofop-ethyl, quizalofop-P-ethyl, clodinafop-propargyl, cyhalofop-butyl, diclofop-methyl, fenoxaprop-P-ethyl, fluazifop-P-butyl, haloxyfop-methyl, haloxyfop-R-methyl), saflufenacil, sethoxydim, siduron, simazine, simetryn, sulcotrione, sulfentrazone, tebuthiuron, tembotrione, tepraloxydim, terbacil, terbumeton, terbuthylazine, thaxtomin (e.g., the thaxtomins described in U.S. Pat. No. 7,989,393), thiencarbazone-methyl, thenylchlor, tralkoxydim, triclopyr, trietazine, trifloxysulfuron, tropramezone, salts and esters thereof, racemic mixtures and resolved isomers thereof and combinations thereof. In an embodiment, compositions comprise acetochlor, clethodim, dicamba, flumioxazin, fomesafen, glyphosate, glufosinate, mesotrione, quizalofop, saflufenacil, sulcotrione, S-3100 and/or 2,4-D, and combinations thereof.

In some embodiments, compositions comprising 3-phenyl-5-(thiophen-2-yl)-1,2,4-oxadiazole) of Formula Ia-i further comprise one or more suitable herbicide or plant growth regulator. The herbicides may be a pre-emergent herbicide, a post-emergent herbicide, or a combination thereof. Non-limiting examples of suitable herbicides or plant growth regulators may comprise one or more compounds selected from the group consisting of;

(1) acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, potassium-heptanoate and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, isobutyl, -isooctyl, -isopropylammonium, -potassium, -triisopropanolammonium, and -trolamine, 2,4-DB, 2,4-DB-butyl, dimethylammonium, -isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridin-2-yl)oxy]acetat, F-9960, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i. e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, isopropylammonium, diammonium, dimethylammonium, -potassium, -sodium, and trimesium, H-9201, i.e. O-(2,4-dimethyl-6-nitrophenyl)O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2,3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, potassium and sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, isopropylammonium, -potassium, and sodium. MCPB, MCPB-methyl, -ethyl, and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide. NGGC-011, napropamide. NC-310, i.e. [5-(benzyloxy)-1-methyl-1H-pyrazol-4-yl](2,4-dichlorophenyl)methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn. SL-261, sulcotrion, sulfentrazone, sulfo-meturon, sulfometuron-methyl, sulfosulfuron, SYN-523, SYP-249, i.e. I-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid). TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vemolate and ZJ-0862, i.e. 3,4-dichloro-N-{2-[(4,6-dimethoxypyrimidin-2-yl)oxy]benzyl}aniline; and

(2) plant growth regulators selected from the group comprising of acibenzolar, acibenzolar-S-methyl, 5-aminolevulinic acid, ancymidol, 6-benzylaminopurine, Brassinolid, catechine, chlormequat chloride, cloprop, cyclanilide, 3-(cycloprop-1-enyl) propionic acid, daminozide, dazomet, n-decanol, dikegulac, dikegulac-sodium, endothal, endothal-dipotassium, disodium, and -mono(N,N-dimethylalkylammonium), ethephon, flumetralin, flurenol, flurenol-butyl, flurprimidol, forchlorfenuron, gibberellic acid, inabenfide, indol-3-acetic acid (IAA), 4-indol-3-yl butyric acid, isoprothiolane, probenazole, jasmonic acid, maleic hydrazide, mepiquat chloride, 1-methylcyclopropene, methyl jasmonate, 2-(1-naphthyl)acetamide, 1-naphthylacetic acid, 2-naphthyloxyacetic acid, nitrophenolate-mixture, paclobutrazol, N-(2-phenylethyl)-beta-alanine. N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole and uniconazole-P.

Additional examples of herbicides that may be included in compositions in some embodiments may be found in Hager, Weed Management, Illinois Agronomy Handbook (2008); and Loux et al., Weed Control Guide for Ohio, Indiana and Illinois (2015), the contents and disclosures of which are incorporated herein by reference. Commercial herbicides may be used in accordance with a manufacturer's recommended amounts or concentrations.

In some embodiments, the composition comprises one or more biopesticidal agents the presence and/or output of which is toxic to at least one plant, including for example, weeds. Examples of biopesticides that may be included or used in compositions in some embodiments may be found in BURGES, supra; HALL & MENN, BIOPESTICIDES: USE AND DELIVERY (Humana Press) (1998); McCoy et al., Entomogenous fungi, in CRC HANDBOOK OF NATURAL PESTICIDES. MICROBIAL PESTICIDES, PART A. ENTOMOGENOUS PROTOZOA AND FUNGI (C. M. Inoffo, ed.), Vol. 5:151-236 (1988); SAMSON et al., ATLAS OF ENTOMOPATHOGENIC FUNGI (Springer-Verlag, Berlin) (1988); and deFaria and Wraight, Mycoinsecticides and Mycoacaricides: A comprehensive list with worldwide coverage and international classification of composition types, BIOL. CONTROL (2007), the contents and disclosures of which are incorporated herein by reference.

Additional Agents

In some embodiments, the composition comprises one or more additional agents.

In some embodiments, the composition comprises one or more beneficial biologically active agents such as biostimulants and/or microbial inoculants. Biostimulants or inoculants may enhance ion uptake, nutrient uptake, nutrient availability or delivery, or a combination thereof. Non-limiting examples of biostimulants or inoculants that may be included or used in compositions may include bacterial extracts (e.g., extracts of one or more diazotrophs, phosphate-solubilizing microorganisms and/or biopesticides), fungal extracts, humic acids (e.g., potassium humate), fulvic acids, myo-inositol, and/or glycine, and any combinations thereof. According to some embodiments, the biostimulants or inoculants may comprise one or more Azospirillum (e.g., an extract of media comprising A. brasilense INTA Az-39), one or more Bradyrhizobium (e.g., an extract of media comprising B. elkanii SEMIA 501, B. elkanii SEMIA 587, B. elkanii SEMIA 5019, B. japonicum NRRL B-50586 (also deposited as NRRL B-59565), B. japonicum NRRL B-50587 (also deposited as NRRL B-59566), Bacillus amyloliquefaciens TJ1000 (also known as 1BE, isolate ATCC BAA-390), B. japonicum NRRL B-50588 (also deposited as NRRL B-59567), B. japonicum NRRL B-50589 (also deposited as NRRL B-59568), B. japonicum NRRL B-50590 (also deposited as NRRL B-59569), B. japonicum NRRL B-50591 (also deposited as NRRL B-59570), Trichoderma virens G1-3 (ATCC 57678), Trichoderma virens G1-21 (Thermo Trilogy Corporation, Wasco, Calif.), Trichoderma virens G1-3 and Bacillus amyloliquefaciens FZB24, Trichoderma virens G1-3 and Bacillus amyloliquefaciens NRRL B-50349, Trichoderma virens G1-3 and Bacillus amyloliquefaciens TJ1000, Trichodermau virens G1-21 and Bacillus amyloliquefaciens FZB24. Trichoderma virens G1-21 and Bacillus amyloliquefaciens NRRL B-50349, Trichoderma virens G1-21 and Bacillus amyloliquefaciens TJ1000, Trichoderma viride TRIECO® (Ecosense Labs. (India) Pvt. Ltd., India. BIO-CURE® F from T. Stanes & Co. Ltd., Indien), Trichoderma viride TV 1 (Agribiotec srl, Italy), Trichoderma viride ICC080, and/or Ulocladium oudemansii HRU3 (BOTRY-ZEN®, Botry-Zen Ltd, NZ), B. japonicum NRRL B-50592 (also deposited as NRRL B-59571), B. japonicum NRRL B-50593 (also deposited as NRRL B-59572), B. japonicum NRRL B-50594 (also deposited as NRRL B-50493), B. japonicum NRRL B-50608, B. japonicum NRRL B-50609, B. japonicum NRRL B-50610, B. japonicum NRRL B-50611, B. japonicum NRRL B-50612, B. japonicum NRRL B-50726, B. japonicum NRRL B-50727, B. japonicum NRRL B-50728, B. japonicum NRRL B-50729, B. japonicum NRRL B-50730, B. japonicum SEMIA 566, B. japonicum SEMIA 5079, B. japonicum SEMIA 5080, B. japonicum USDA 6, B. japonicum USDA 110, B. japonicum USDA 122, B. japonicum USDA 123, B. japonicum USDA 127, B. japonicum USDA 129 and/or B. japonicum USDA 532C), one or more Rhizobium extracts (e.g., an extract of media comprising R. leguminosarum SO12A-2), one or more Sinorhizobium extracts (e.g., an extract of media comprising S. fredii CCBAU 114 and/or S. fredii USDA 205), one or more Penicillium extracts (e.g., an extract of media comprising P. bilaiae ATCC 18309, P. bilaiae ATCC 20851, P. bilaiae ATCC 22348, P. bilaiae NRRL 50162. P. bilaiae NRRL 50169, P. bilaiae NRRL 50776, P. bilaiae NRRL 50777, P. bilaiae NRRL 50778, P. bilaiae NRRL 50777, P. bilaiae NRRL 50778, P. bilaiae NRRL 50779, P. bilaiae NRRL 50780, P. bilaiae NRRL 50781, P. bilaiae NRRL 50782, P. bilaiae NRRL 50783. P. bilaiae NRRL 50784. P. bilaiae NRRL 50785, P. bilaiae NRRL 50786, P. bilaiae NRRL 50787, P. bilaiae NRRL 50788, P. bilaiae RS7B-SD 1, P. brevicompactum AgRF18, P. canescens ATCC 10419, P. expansum ATCC 24692, P. expansum YT02, P. fellatanum ATCC 48694, P. gaestrivorus NRRL 50170, P. glabrum DAOM 239074, P. glabrum CBS 229.28. P. janthinellum ATCC 10455, P. lanosocoeruleum ATCC 48919, P. radicum ATCC 201836, P. radicum FRR 4717, P. radicum FRR 4719, P. radicum N93/47267 and/or P. raistrickii ATCC 10490), one or more Pseudomonas extracts (e.g., an extract of media comprising P. jessenii PS06), one or more acaricidal, insecticidal and/or nematicidal extracts (e.g., an extract of media comprising Bacillus firmus 1-1582, Bacillus mycoides AQ726, NRRL B-21664; Beauveria bassiana ATCC-74040, Beauveria bassiana ATCC-74250, Burkholderia sp. A396 sp. nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium animsopliae strain 52, Metarhizium anisopliae strain 7. Metarhizium anisopliae strain 43 and Metarhizium anisopliae BIO-1020, TAE-001; deposited as DSM 3884, DSM 3885, ATCC 90448, SD 170 and ARSEF 7711) and/or Paecilomyces fumosoroseus FE991), and/or one or more fungicidal extracts (e.g., an extract of media comprising Ampelomyces quisqualis AQ 10® (Intrachem Bio GmbH & Co. KG, Germany), Aspergillus flavus AFLA-GUARD (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087. Bacillus AQ175 (ATCC 55608), Bacillus AQ 177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens NRRL B-50349, Bacillus amyloliquefaciens TJ1000 (also known as 1BE, isolate ATCC BAA-390), Bacillus thuringiensis AQ52 (NRRL B-21619), Candida oleophila 1-82 (e.g., ASPIRE® from Ecogen Inc., USA), Candida saitoana BIOCURE® (in mixture with lysozyme; BASF, USA) and BIOCOAT® (ArystaLife Science, Ltd., Cary, N.C.), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I.A.P.A., Italy) and FUSACLEAN® (Natural Plant Protection, France). Metschnikowia fructicola SHEMER® (Agrogreen. Israel). Microdochium dimerum ANTIBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone BioInnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9R and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus V117b (PROTUS. Prophyta, Germany). Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®, Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E.P.L.A.C., Brazil), Trichoderma virens GL-21 (SOILGARD®, Certis LLC, USA), Trichoderma virens G1-3, ATCC 57678. Trichoderma virens G1-21 (Thermo Trilogy Corporation, Wasco, Calif.). Trichoderma virens G1-3 and Bacillus amyloliquefaciens FZB2, Trichoderma virens G1-3 and Bacillus amyloliquefaciens NRRL B-50349, Trichoderma virens G1-3 and Bacillus amyloliquefaciens TJ1000, Trichoderma virens G1-21 and Bacillus amyloliquefaciens FZB24, Trichoderma virens G1-21 and Bacillus amyloliquefaciens NRRL B-50349, Trichoderma virens G1-21 and Bacillus amyloliqueficiens TJ1000. Trichoderma viride TRIECO-® (Ecosense Labs. (India) Pvt. Ltd., Indien, BIO-CURE® F from T. Stanes & Co. Ltd., Indien), Trichoderma viride TV1 (Agribiotec srl, Italy), Trichoderma viride ICC080, and/or Ulocladium oudemansii HRU3 (BOTRY-ZEN®, Botry-Zen Ltd. NZ)), and combinations thereof.

In some embodiments, the composition comprises one or more beneficial microbes. Non-limiting examples of such microbes include beneficial microbes selected from the following genera: Actinomycetes, Agrobacterium, Arthrobacter, Alcaligenes, Acinetobacter spp. Azospirillum spp, Aureobacterium, Azobacter, Azorhizobium, Bacillus, Beijerinckia, Bradyrhizobium, Brevibacillus, Burkholderia, Chromobacterium, Chryseomonas spp., Clostridium, Clavibacter, Comamonas, Corynebacterium, Curtobacterium, Enterobacter, Eupenicillium spp., Exiguobacteriumn spp., Flavobacterum, Gluconobacter, Hydrogenophaga, Hymenoscyphous. Klebsiella, Kluyvera spp., Methylobacterium, Paenihacillus, Pasteuria, Photorhabdus, Phyllobacterium, Pseudomonas, Rhizobium, Rhizobacter, Rhizopogon. Serratia, Sinorhizobium, Sphingobacterium, Swaminathania spp., Stenotrophomonas, Streptomyces spp., Thiobacillus, Variovorax, Vibrio, Xanthobacter, Xanthomonas and Xenorhabdus, or any combination thereof. According to some embodiments, the composition comprises one or more of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium subtsugae, Pasteuria penetrans, Pasteuria usage, and Pseudomona fluorescens. According to some embodiments, a microbe may comprise a fungus of the genus Alternaria, Ampelomyces, Arthrobotrys spp., Aspergillus, Aureobasidium, Beauveria, Candida spp., Colletotrichum, Coniothyrium, Gigaspora spp., Gliocladium, Glomus spp., Laccaria spp., Metarhizium, Mucor spp., Muscodor, Oidiodendron spp., Paecilomyces, Penicillium spp., Pisolithus spp., Scleroderma, Trichoderma, Typhula, Ulocladium, and Verticillium. In another aspect, a fungus is Beauveria bassiana, Coniothrium minitans, Gliocladium virens, Muscodor albus, Paecilomyces lilacinus, or Trichoderma polysporum.

In some embodiments, the composition comprises one or more lipo-chitooligosaccharides (LCOs), chitin oligomer(s) and/or chitosan oligomer(s) (collectively referred to hereinafter as COs), and/or chitinous compounds.

LCOs, sometimes referred to as symbiotic nodulation (Nod) signals (or Nod factors) or as Myc factors, consist of an oligosaccharide backbone of β-1,4-linked N-acetyl-D-glucosamine (“GlcNAc”) residues with an N-linked fatty acyl chain condensed at the non-reducing end. As understood in the art. LCOs differ in the number of GlcNAc residues in the backbone, in the length and degree of saturation of the fatty acyl chain and in the substitutions of reducing and non-reducing sugar residues. See. e.g., Denarie et al., Ann. Rev. Biochem. 65:503 (1996); Diaz et al., Mol. Plant-Microbe Interactions 13:268 (2000); Hungria et al., Soil Biol. Biochem. 29:819 (1997); Hamel et al., Planta 232:787 (2010); and Prome et al., Pure & Appl. Chem. 70(1):55 (1998), the contents and disclosures of which are incorporated herein by reference.

LCOs may be synthetic or obtained from any suitable source. See, e.g., WO 2005/063784. WO 2007/117500 and WO 2008/071674, the contents and disclosures of which are incorporated herein by reference. In some aspects, a synthetic LCO may have the basic structure of a naturally occurring LCO but contains one or more modifications or substitutions, such as those described in Spaink, Crit. Rev. Plant Sci. 54:257 (2000). LCOs and precursors for the construction of LCOs (e.g., COs, which may themselves be useful as a biologically active ingredient) can be synthesized by genetically engineered organisms. See, e.g., Samain et al., Carbohydrate Res. 302:35 (1997); Cottaz et al., Meth. Eng. 7(4):311 (2005); and Samain et al., J. Biotechnol. 72:33 (1999) (e.g., FIG. 1 therein, which shows structures of COs that can be made recombinantly in E. coli harboring different combinations of genes nodBCHL), the contents and disclosures of which are incorporated herein by reference.

LCOs (and derivatives thereof) may be included or utilized in compositions in various forms of purity and can be used alone or in the form of a culture of LCO-producing bacteria or fungi. For example, OPTIMIZE® (commercially available from Monsanto Company (St. Louis, Mo.)) contains a culture of Bradyrhizobtium japonicum that produces LCO. Methods to provide substantially pure LCOs include removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC and the purified LCO molecules can be freeze-dried for long-term storage. According to some embodiments, the LCO(s) included in compositions of the present disclosure is/are at least 0.1%, 0.5%, 1%, 2%, 3%, 4%, 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99% or 100% pure. Compositions and methods in some embodiments may comprise analogues, derivatives, hydrates, isomers, salts and/or solvates of LCOs. LCOs may be incorporated into compositions of the present disclosure in any suitable amount(s)/concentration(s). For example, compositions of the present disclosure comprise about 1×10⁻²⁰ M to about 1×10⁻¹ M LCO(s). For example, compositions of the present disclosure can comprise about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹M, 1×10⁻¹⁰ M, 1×10⁻⁹ M, 1×10⁻⁸ M, 1×10⁻⁷ M, 1×10⁻⁶ M, 1×10⁻⁵ M, 1×10⁻⁴ M, 1×10⁻³ M, 1×10⁻² M, 1×10⁻¹ M of one or more LCOs. In an aspect, the LCO concentration is 1×10⁻¹⁴ M to 1×10⁻⁵ M, 1×10⁻¹² M to 1×10⁻⁶ M, or 1×10⁻¹⁰ M to 1×10⁻⁷ M. In an aspect, the LCO concentration is 1×10⁻¹⁴M to 1×10⁻⁵ M, 1×10⁻¹² M to 1×10⁻⁶ M, or 1×10⁻¹⁰ M to 1×10⁻⁷ M. The amount/concentration of LCO may be an amount effective to impart a positive trait or benefit to a plant, such as to enhance the disease resistance, growth and/or yield of the plant to which the composition is applied. According to some embodiments, the LCO amount/concentration is not effective to enhance the yield of the plant without beneficial contributions from one or more other constituents of the composition, such as CO and/or one or more pesticides.

In some embodiments, the composition comprises one or more chitin oligomers and/or chitosan oligomers. See, e.g., D'Haeze et al., Glycobiol. 12(6):79R (2002); Demont-Caulet et al., Plant Physiol. 120(1):83 (1999); Hanel et al., Planta 232:787 (2010); Muller et al., Plant Physiol. 124:733 (2000); Robina et al., Tetrahedron 58:521-530 (2002); Rouge et al., Docking of Chitin Oligomers and Nod Factors on Lectin Domains of the LysM-RLK Receptors in the Medicago-Rhizobium Symbiosis, in The Molecular Immunology of Complex Carbohydrates-3 (Springer Science, 2011); Van der Hoist et al., Curr. Opin. Struc. Biol. 11:608 (2001); and Wan et al., Plant Cell 21:1053 (2009), the contents and disclosures of which are incorporated by reference. COs may be obtained from any suitable source. For example, COs may be derived from an LCO. For example, in an aspect, compositions comprise one or more COs derived from an LCO obtained (i.e., isolated and/or purified) from a strain of Azorhizobium, Bradyrhizobium (e.g., B. japonicum), Mesorhizobium, Rhizobium e.g., R. leguminosarum), Sinorhizobium (e.g., S. meliloti), or mycorhizzal fungi (e.g., Glomus intraradicus). Alternatively, the CO may be synthetic. Methods for the preparation of recombinant COs are known in the art. See, e.g., Cottaz et al., Meth. Eng 7(4):311 (2005); Samain et al., Carbohydrate Res. 302:35 (1997); and Samain et al. J. Biotechnol. 72:33 (1999), the contents and disclosures of which are incorporated herein by reference.

COs (and derivatives thereof) may be included or utilized in compositions in various forms of purity and can be used alone or in the form of a culture of CO-producing bacteria or fungi. According to some embodiments, the CO(s) included in compositions may be at least 0.1%, 0.5%, 1%, 2%, 3%, 4%, 5%, 6%, 7%, 8%, 9%, 10%, 15%, 20%, 30%, 40%, 50%, 60%, 70%, 75%, 80%, 85%, 90%, 91%, 92%, 93%, 94%, 95%, 96%, 97%, 98%, 99%, 99.5% or more pure. It is to be understood that compositions and methods of the present disclosure can comprise hydrates, isomers, salts and/or solvates of COs. COs in some embodiments may be incorporated into compositions in any suitable amount(s)/concentration(s). For example, compositions in some embodiments may comprise about 1×10⁻²⁰ M to about 1×10⁻¹ M COs, such as about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹ M, 1×10⁻¹⁰ M, 1×10⁻⁹ M, 1×10⁻⁸ M, 1×10⁻⁷ M, 1×10⁻⁶ M, 1×10⁻⁵ M, 1×10⁻⁴ M, 1×10⁻³ M, 1×10⁻² M or 1×10⁻¹ M of one or more COs. For example, the CO concentration may be 1×10⁻¹⁴ M to 1×10⁻⁵ M, 1×10⁻¹² M to 1×10⁻⁶ M, or 1×10⁻¹⁰ M to 1×10⁻⁷ M. The amount/concentration of CO may be an amount effective to impart or confer a positive trait or benefit to a plant, such as to enhance the soil microbial environment, nutrient uptake, or increase the growth and/or yield of the plant to which the composition is applied. Compositions in some embodiments may comprise one or more suitable chitinous compounds, such as, for example, chitin (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxymethyl)oxan-3-yI]methoxymethyl]-4-hydroxy-6-(hydroxymethyl)oxan-3-ys]ethanamide), chitosan (IUPAC: 5-amino-6-[5-amino-6-[5-amino-4,6-dihydroxy-2(trydroxymethypoxan-3-yl]oxy-4-hydroxy-2-(hydroxymethyl)oxan-3-yl]oxy-2(hydroxymethyl)oxane-3,4-diol), and isomers, salts and solvates thereof.

Chitins and chitosans, which are major components of the cell walls of fungi and the exoskeletons of insects and crustaceans, are composed of GlcNAc residues. Chitins and chitosans may be obtained commercially or prepared from insects, crustacean shells, or fungal cell walls. Methods for the preparation of chitin and chitosan are known in the art. See, e.g., U.S. Pat. No. 4,536,207 (preparation from crustacean shells) and U.S. Pat. No. 5,965,545 (preparation from crab shells and hydrolysis of commercial chitosan); and Pochanavanich et al., Lett. Appl. Microbiol. 35:17 (2002) (preparation from fungal cell walls).

Deacetylated chitins and chitosans may be obtained that range from less than 35% to greater than 90% deacetylation and cover a broad spectrum of molecular weights, e.g.; low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulated for seed treatment are commercially available. Commercial products include, for example, ELEXA® (Plant Defense Boosters, Inc.) and BEYOND™ (Agrihouse, Inc.).

In some embodiments, the composition comprises one or more suitable flavonoids, including, but not limited to, anthocyanidins, anthoxanthins, chalcones, coumarins, flavanones, flavanonols, flavans and isoflavonoids, as well as analogues, derivatives, hydrates, isomers, polymers, salts and solvates thereof. Flavonoids are phenolic compounds having the general structure of two aromatic rings connected by a three-carbon bridge. Classes of flavonoids are known in the aft See, e.g., Jain et al., J. Plant Biochem. &Biotechnol. 11:1 (2002); and Shaw et al., Environ. Microbiol. 11:1867 (2006); the contents and disclosures of which are incorporated herein by reference. Several flavonoid compounds are commercially available. Flavonoid compounds may be isolated from plants or seeds, e.g., as described in U.S. Pat. Nos. 5,702,752; 5; 990,291; and 6,146,668. Flavonoid compounds may also be produced by genetically engineered organisms, such as yeast, See, e.g. Ralston et al., Plant Physiol. 137:1375 (2005).

In some embodiments, the composition comprises one or more flavanones, such as one or more of butin, eriodictyol, hesperetin, hesperidin, homoeriodictyol, isosakuranetin, naringenin, naringin, pinocembrin, poncirin, sakuranetin, sakuranin, and/or sterubin, one or more flavanonols, such as dihydrokaempferol and/or taxifolin, one or more flavans, such as one or more flavan-3-ols catechin (C), catechin 3-gallate (Cg), epicatechins (EC), epigallocatechin (EGC) epicatechin 3-gallate (ECg), epigalicatechin 3-gallate (EGCg), epiafzelechin, fisetirudol gallocatechin (GC), gallcatechin 3-gallate (GCg), guibourtinidol, mesquitol, robinetinidol, theaflavin-3-gallate, theaflavin-3′-gallate, the flavin-3,3′-digallate, thearubigin), flavan-4-ols (e.g., apiforol and or luteoforol) and/or flavan-3,4-diols (e.g., leucocyanidin, leucodelphinidin, leucofisetinidin, leucomalvidin, luecopelargonidin, leucopeonidin, leucorobinetinidin, melacacidin and/or teracacidin) and/or dimers, trimers, oligomers and/or polymers thereof (e.g., one or more proanthocyanidins), one or more isoflavonoids, such as one or more isoflavones or flavonoid derivatives (e.g, biochanin A, daidzein, formononetin, genistein and/or glycitein), isoflavanes (e.g., equol, ionchocarpane and/or laxifloorane), isoflavandiols, isoflavenes glabrene, haginin D and/or 2-methoxyjudaicin), coumestans (e.g., coumestrol, plicadin and/or wedelolactone), pterocarpans, roetonoids, neoflavonoids (e.g, calophyllolide, coutareagenin, dalbergichromene, dalbergin, nivetin), and/or pterocarpans (e.g., bitucarpin A, bitucarpin B, erybraedin A, erybraedin B, erythrabyssin II, erthyrabissin-1, erycristagallin, glycinol, glyceollidins, glyceollins, glycyrrhizol, maackiain, medicarpin, morisianine, orientanol, phaseolin, pisatin, striatine, trifolirhizin), and combinations thereof. Flavonoids and their derivatives may be included in compositions in any suitable form, including, but not limited to, polymorphic and crystalline forms. Flavonoids may be included in compositions in any suitable amount(s) or concentration(s). The amount/concentration of a flavonoid(s) may be an amount effective, which may be indirectly through activity on soil microorganisms or other means, such as to enhance plant nutrition and/or yield. According to some embodiments, a flavonoid amount/concentration may not be effective to enhance the nutrition or yield of the plant without the beneficial contributions from one or more other ingredients of the composition, such as LCO, CO, and/or one or more pesticides.

In some embodiments, the composition comprises one or more non-flavonoid nod-gene inducer(s), including, but not limited to, jasmonic acid ([1R-[1α,2β(Z)]]-3-oxo-2-(pentenyl)cyclopentarieacetic acid; JA), linoleic acid ((Z,Z)-9,12-Octadecadienoic acid) and/or linolenic acid ((Z,Z,Z)-9,12,15-octadecatrienoic acid), and analogues, derivatives, hydrates, isomers, polymers, salts and solvates thereof. Jasmonic acid and its methyl ester, methyl jasmonate (MeJA); collectively known as jasmonates, are octadecanoid-based compounds that occur naturally in some plants (e.g., wheat), fungi (e.g., Botryodiplodia theobromae, Gibberella fujikuroi) yeast (e.g., Saccharomyces cerevistae) and bacteria (e.g., Escherichia coli). Linoleic acid and linolenic acid may be produced in the course of the biosynthesis of jasmonic acid.

Derivatives of jasmonic acid, linoleic acid, and linolenic acid that may be included or used in compositions in some embodiments include esters, amides, glycosides and salts thereof. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group; an alkenyl group, such as a. C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are each independently; a hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters may be prepared by known methods, such as acid-catalyzed nucleophilic addition, wherein the carboxylic acid is reacted with an alcohol in the presence of a catalytic amount of a mineral acid. Amides may also be prepared by known methods, such as by reacting the carboxylic acid with the appropriate amine in the presence of a coupling agent, such as dicyclohexyl carbodiimide (DCC), under neutral conditions. Suitable salts of linoleic acid, linolenic acid and jasmonic acid include, for example, base addition salts. The bases that may be used as reagents to prepare metabolically acceptable base salts of these compounds include those derived from cations such as alkali metal cations (e.g., potassium and sodium) and alkaline earth metal cations (e.g., calcium and magnesium). These salts may be readily prepared by mixing a solution of linoleic acid, linolenic acid, or jasmonic acid with a solution of the base. The salts may be precipitated from solution and collected by filtration, or may be recovered by other means such as by evaporation of the solvent.

In some embodiments, the composition comprises one or more plant growth regulators including, but not limited to, ethephon and/or thidiazuron.

In some embodiments, the composition comprises one or more karrakins, including but not limited to 2H-furo[2,3-c]pyran-2-ones, as well as analogues, derivatives, hydrates, isomers, polymers, salts and solvates thereof. Examples of biologically acceptable salts of karrakins include acid addition salts formed with biologically acceptable acids, examples of which include hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzenesulphonate and p-toluenesulphonic acid. Additional biologically acceptable metal salts may include alkali metal salts, with bases, examples of which include the sodium and potassium salts, Karrakins may be incorporated into compositions in any suitable amount(s) or concentration(s). For example, the amount/concentration of a karrakin may be an amount or concentration effective to impart or confer a positive trait or benefit to a plant, such as to enhance the disease resistance, growth and/or yield of the plant to which the composition is applied. In an aspect, a karrakin amount/concentration may not be effective to enhance the disease resistance, growth and/or yield of the plant without beneficial contributions from one or more other ingredients of the composition, such as a LCO, CO and/or one or more pesticides.

In some embodiments, the composition comprises one or more anthocyanidins and/or anthoxanthins, such as one or more of cyanidin, delphinidin, malvidin, pelargonidin, peonidin, petunidin, flavones (e.g., apigenin, baicalein, chrysin, 7,8-dihydroxyflavone, diosmin, flavoxate, 6-hydroxyflavone, luteolin, scutellarein, tangeritin and/or wogonin) and/or flavonols (e.g., amurensin, astragalin, azaleatin, azalein, fisetin, furanoflavonols galangin, gossypetin, 3-hydroxyflavone, hyperoside, icariin, isoquercetin, kaempferide, kaempferitrin, kaempferol, isorhamnetin, morin, myricetin, myricitrin, natsudaidain, pachypodol, pyranoflavonols quercetin, quericitin, rhamnazin, rhamnetin, robinin, rutin, spiraeoside, troxerutin and/or zanthorhamnin), and combinations thereof.

In some embodiments, the composition comprises one or more gluconolactone and/or an analogue, derivative, hydrate, isomer, polymer, salt and/or solvate thereof. Gluconolactone may be incorporated into compositions in any suitable amount(s)/concentration(s). For example, the amount/concentration of a gluconolactone amount/concentration may be an amount effective to impart or confer a positive trait or benefit to a plant, such as to enhance the disease resistance, growth and/or yield of the plant to which the composition is applied. In an aspect, the gluconolactone amount/concentration may not be effective to enhance the disease resistance, growth and/or yield of the plant without beneficial contributions from one or more other ingredients of the composition, such as a LCO, CO and/or one or more pesticides.

In some embodiments, the composition comprises one or more nutrient(s) and/or fertilizer(s), such as organic acids (e.g., acetic acid, citric acid, lactic acid, malic acid, taurine, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), vitamins, (e.g., vitamin A, vitamin B complex (i.e., vitamin B1, vitamin B2, vitamin B3, vitamin B5, vitamin B6, vitamin B7, vitamin B8, vitamin B9, vitamin B12, choline) vitamin C, vitamin D, vitamin E, vitamin K.), and/or carotenoids (α-carotene, β-carotene, cryptoxanthin, lutein, lycopene, zeaxanthin, etc.), and combinations thereof. In an aspect, compositions of the present disclosure may comprise macro- and micronutrients of plants or microbes, including phosphorous, boron, chlorine, copper, iron, manganese, molybdenum and/or zinc. According to some embodiments, compositions may comprise one or more beneficial micronutrients. Non-limiting examples of micronutrients for use in compositions described herein may include vitamins, (e.g., vitamin A, vitamin 13 complex (i.e., vitamin 91, vitamin B2, vitamin 93, vitamin B5, vitamin 96, vitamin B7, vitamin 98, vitamin B9, vitamin B12, choline) vitamin C, vitamin D, vitamin E, vitamin K, carotenoids (α-carotene, β-carotene, cryptoxanthin, lutein, lycopene, zeaxanthin, etc.), macrominerals phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), organic acids (e.g., acetic acid, citric acid, lactic acid, malic acid, taurine, etc.), and combinations thereof. In a particular aspect, compositions may comprise phosphorous, boron, chlorine, copper, iron, manganese, molybdenum, and/or zinc, and combinations thereof. For compositions comprising phosphorous, it is envisioned that any suitable source of phosphorous may be used. For example, phosphorus may be derived from a rock phosphate source, such as monoammonium phosphate, diammonium phosphate, monocalcium phosphate, super phosphate, triple super phosphate, and/or ammonium polyphosphate, an organic phosphorous source, or a phosphorous source capable of solubilization by one or more microorganisms (e.g., Penicillium bilaiae).

Storage Stability

The aqueous nematicidal compositions described herein exhibit commercially acceptable storage stability across a wide range of temperatures and environmental conditions. In the context of embodiments described herein, storage stability is generally defined as the absence of sedimentation and the lack of any significant change in the rheological properties of the composition. For example, stable compositions are observed to have consistent particle size and/or active (e.g., 3,5-disubstituted-1,2,4-oxadiazole) content over time. In the compositions described herein, stability may also be observed where the composition lacks any significant change in viscosity over time. Commercially acceptable storage stability can be reliably achieved by selecting the various components of the aqueous nematicidal composition, particularly when selecting the dispersant package in accordance with the respective embodiments described in detail above and in the Examples set forth below.

The aqueous nematicidal composition may be storage-stable at 25° C. for at least about 2 days, at least about 4 days, at least about 1 week, at least about 1.5 weeks, at least about 2 weeks, at least about 2.5 weeks, at least about 3 weeks, at least about 3.5 weeks, at least about 1 month, at least about 2 months, at least about 3 months, at least about 6 months, at least about 12 months or at least about 18 months.

In some embodiments, the aqueous nematicidal composition may be storage-stable at elevated temperatures greater than 50° C.) for at least about 2 days, at least about 4 days, at least about 1 week, at least about 1.5 weeks, at least about 2 weeks, at least about weeks, at least about 3 weeks, at least about 3.5 weeks, at least about 1 month, at least about 2 months, at least about 3 months, at least about 6 months, at least about 12 months or at least about 18 months.

Methods of Preparing Treated Seeds

Various methods of preparing treated seeds wherein the seed coating comprises an aqueous nematicidal composition comprising a 3,5-disubstituted-1,2,4-oxadiazole and a dispersant component comprising a polyarylphenol alkoxylate and a second dispersant are provided below.

For example, the method of preparing a treated seed can comprise mixing a nematicidal composition comprising a 3,5-disubstituted-1,2,4-oxadiazole with the dispersant package to form a seed treatment mixture, and applying the seed treatment mixture to a seed. For example, the dispersant package may be a such that the crystallization of the 3,5-disubstituted-1,2,4-oxadiazole is inhibited.

Typically, the 3,5-disubstituted-1,2,4-oxadiazole compound and dispersant package are mixed to form a seed treatment mixture prior to application of the seed treatment mixture to the seed. Even though the nematicidal composition typically comprises a high concentration of the 3,5-disubstituted-1,2,4-oxadiazole, nematicidal compositions further comprising the described dispersant packages have been found to be storage stable (e.g., the mixture is not prone to separate into different phases) for extended periods of time.

Types of Seeds

The methods described herein can be used in connection with any species of plant and/or the seeds thereof. In some embodiments, however, the methods are used in connection with seeds of plant species that are agronomically important. In particular, the seeds can be of corn, peanut, canola/rapeseed, soybean, cucurbits, crucifers, cotton, beets, rice, sorghum, sugar beet, wheat, barley, lye, sunflower, tomato, sugarcane, tobacco, oats, as well as other vegetable and leaf crops. In some embodiments, the seed is corn, soybean, or cotton seed. The seed may be a transgenic seed from Which a transgenic plant can grow and incorporate a transgenic event that confers, for example, tolerance to a particular herbicide or combination of herbicides, increased disease resistance, enhanced tolerance to stress and/or enhanced yield. Transgenic seeds include, but are not limited to, seeds of corn, soybean and cotton.

Methods of Applying the Seed Coating

The composition can be applied to seeds by any standard seed treatment methodology known in the art, including but not limited to mixing in a container (e.g., a bottle or bag), mechanical application, tumbling, spraying, immersion, and solid matrix priming. Seed coating methods and apparatus for their application are disclosed in, for example, U.S. Pat. Nos. 5,918,413, 5,891,246, 5,554.445, 5,389,399, 5,107,787, 5,080,925, 4,759,945 and 4,465,017, among others, which are incorporated herein by reference. Any conventional active or inert material can be used for contacting seeds with the seed treatment composition, such as conventional film-coating materials including but not limited to water-based film-coating materials.

For example, in one embodiment, a seed treatment composition can be introduced onto or into a seed by use of solid matrix priming. For example, a quantity of the seed treatment composition can be mixed with a solid matrix material and then the seed can be placed into contact with the solid matrix material for a period to allow the seed treatment composition to be introduced to the seed. The seed can then optionally be separated from the solid matrix material and stored or used, or the mixture of solid matrix material plus seed can be stored or planted directly. Solid matrix materials which are useful in compositions described herein include polyacrylamide, starch, clay, silica, alumina, talc, mica, soil, sand, polyurea, polyacrylate, or any other material capable of absorbing or adsorbing the seed treatment composition for a time and releasing the nematicide of the seed treatment composition into or onto the seed. It is useful to make sure that the nematicide and the solid matrix material are compatible with each other. For example, the solid matrix material should be chosen so that it can release the nematicide at a reasonable rate, for example over a period of minutes, hours, days, or weeks.

Imbibition is another method of treating seed with the seed treatment composition. For example, a plant seed can be directly immersed for a period of time in the seed treatment composition. During the period that the seed is immersed, the seed takes up, or imbibes, a portion of the seed treatment composition. Optionally, the mixture of plant seed and the seed treatment composition can be agitated, for example by shaking, rolling, tumbling, or other means. After imbibition, the seed can be separated from the seed treatment composition and optionally dried, for example by patting or air drying.

The seed treatment composition may be applied to the seeds using conventional coating techniques and machines, such as fluidized bed techniques, the roller mill method, rotostatic seed treaters, and drum coaters. Other methods, such as spouted beds may also be useful. The seeds may be pre-sized before coating. After coating, the seeds are typically dried and then transferred to a sizing machine for sizing. Such procedures are generally known in the art.

If the seed treatment composition is applied to the seed in the form of a coating, the seeds can be coated using a variety of methods known in the art. For example, the coating process can comprise spraying the seed treatment composition onto the seed while agitating the seed in an appropriate piece of equipment such as a tumbler or a pan granulator.

In one embodiment, when coating seed on a large scale (for example a commercial scale), the seed coating may be applied using a continuous process. Typically, seed is introduced into the treatment equipment (such as a tumbler, a Mixer, or a pan granulator) either by weight or by flow rate. The amount of treatment composition that is introduced into the treatment equipment can vary depending on the seed weight to be coated, surface area of the seed, the concentration of the nematicide and/or other active ingredients in the treatment composition, the desired concentration on the finished seed, and the like. The treatment composition can be applied to the seed by a variety of means, for example by a spray nozzle or revolving disc. The amount of liquid is typically determined by the assay of the formulation and the required rate of active ingredient necessary for efficacy. As the seed falls into the treatment equipment the seed can be treated (for example by misting or spraying with the seed treatment composition) and passed through the treater under continual movement/tumbling where it can be coated evenly and dried before storage or use.

In another embodiment, the seed coating may be applied using a batch process. For example, a known weight of seeds can be introduced into the treatment equipment (such as a tumbler, a mixer, or a pan granulator). A known volume of seed treatment composition can be introduced into the treatment equipment at a rate that allows the seed treatment composition to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In an alternative embodiment, the seed coating may be applied using a semi-batch process that incorporates features from each of the batch process and continuous process embodiments set forth above.

In still another embodiment, seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry. For example, the seed may be treated using a WILLY NIKLAUS GBBH seed treating apparatus were the seeds are tumbled inside the treater while a quantity of seed treatment composition is added.

In another embodiment, seeds can also be coated by placing the known amount of seed into a narrow neck bottle or receptacle with a lid. While tumbling, the desired amount of seed treatment composition can be added to the receptacle. The seed is tumbled until it is coated with the treatment composition. After coating, the seed can optionally be dried, for example on a tray.

In some embodiments, the treated seeds may also be enveloped with a film overcoating to protect the nematicidal coating. Such overcoatings are known in the art and may be applied using conventional fluidized bed and drum film coating techniques. The overcoatings may be applied to seeds that have been treated with any of the seed treatment techniques described above, including but not limited to solid matrix priming, imbibition, coating, and spraying, or by any other seed treatment technique known in the art.

In one embodiment, the nematicidal coating composition is adhered to the surface of a seed and comprises a continuous aqueous phase comprising a dispersant component and a dispersed solid particulate phase comprising a 3,5-disubstituted-1,2,4-oxadiazole or a salt thereof. The dispersant component comprises a polyarylphenol alkoxylate or salt thereof and a second dispersant.

Treated Seeds

In one embodiment, a seed is treated with a seed treatment mixture as described herein, including for example a solid compound comprising a 3,5-disubstituted-1,2,4-oxadiazole, dispersant package, and optional additional components. Typically, the seed has been treated with the seed treatment mixture using one of the seed treatment methods set forth above such that the nematicidal coating composition is adhered to the surface of the seed. The seed may be of any plant species, as described above.

In one embodiment, the treated seeds comprise a 3,5-disubstituted-1,2,4-oxadiazole compound in an amount of at least about 0.05 mg/seed, more typically from about 005 to about 1 mg/seed, and even more typically from about 0.05 to about 0.5 mg/seed. In other embodiments, the treated seed has an active loading of the 3,5-disubstituted-1,2,4-oxadiazole compound from the seed treatment mixture of at least about 5%, at least about 10%, at about least 15%, at least about 20%, at least about 25%, at least about 30%, at least about 35%, at least about 40%, at least about 45%, at least about 50%, at least about 55%, at least about 60%, at least about 65%, or at least about 75% by weight. In certain embodiments, the treated seed has an active loading of the 3,5-disubstituted-1,2,4-oxadiazole compound from the seed treatment mixture of at least about 45% by weight. For example, the treated seed may have an active loading of the 3,5-disubstituted-1,2,4-oxadiazole compound from the seed treatment mixture of from about 5% to about 75%, from about 10% to about 70%, from about 15% to about 60%, from about 20% to about 50%, from about 25% to about 50%, from about 30% to about 50%, from about 35% to about 50%, or from about 40% to about 50%.

In one embodiment, the treated seeds comprise 3-phenyl-5-(thiophen-2-yl)-1,2,4-oxadiazole of Formula Ia-i from the seed treatment mixture in an amount of at least about 0.05 mg/seed, more typically from about 0.05 to about 1 mg/seed, and even more typically from about 0.05 to about 0.5 mg/seed. In other embodiments, the treated seed has an active loading of 3-phenyl-5-(thiophen-2-yl)-1,2,4-oxadiazole of Formula Ia-i from the seed treatment mixture of at least about 5%, at least about 10%, at about least 15%, at least about 20%, at least about 25%, at least about 30%, at least about 35%, at least about 40%, at least about 45%, at least about 50%, at least about 55%, at least about 60%, at least about 65%, or at least about 75% by weight. In certain embodiments, the treated seed has an active loading of 3-phenyl-5-(thiophen-2-yl)-1,2,4-oxadiazole of Formula Ia-i from the seed treatment mixture of at least about 45% by weight. For example, the treated seed may have an active loading of 3-phenyl-5-(thiophen-2-yl)-1,2,4-oxadiazol e of Formula Ia-i from the seed treatment mixture of from about 5% to about 75%, from about 10% to about 70%, from about 15% to about 60%, from about 20% to about 50%, from about 25% to about 50%, from about 30% to about 50%, from about 35% to about 50%, or from about 40% to about 50%.

### Examples

The following examples are to be considered as merely illustrative, and are not intended to limit the scope of this invention.

A study was conducted to evaluate certain aqueous nematicidal compositions in the form of a suspension concentrate and comprising a 3,5-disubstituted-1,2,4-oxadiazole compound and different dispersants (i.e., “dispersant packages”), in order to determine which dispersants and/or dispersant combinations reduced crystal growth on an application surface. Each composition tested comprised 45.8 wt % of tioxazafen (i.e., 3-phenyl-5-(thiophen-2-yl)-1,2,4-oxadiazole) as the 3,5-disubstituted-1,2,4-oxadiazole compound along with the other components as detailed below, with a balance of water.

The compositions were prepared by combining each of the listed components and milling the mixture with a SIZEGVARI ATTRITOR milling system made by UNION PROCESS containing stainless steel beads having a diameter of ⅛ inch (3.2 mm) in a 500 mL jacketed metal container. The stirring speed was controlled by a VARIAC variable autotransformer. In each example, the composition was cast as a film on the surface of a LENETA substrate using a drawdown bar. The film was allowed to dry overnight at room temperature. After drying, an initial whiteness value L* (corresponding to the lightness value in the L*a*b* color space) was measured using a VIDEOMETER LAB3 V0101-000-11 color meter and the films were stored in a vacuum oven at 35° C.

The films were inspected again after a number of days (i.e., 4, 7, or 14 days) using a VIDEOMETER LAB3 V0101-000-11 color meter to determine the L* value. From these values, a percentage change in the L* as compared to the initial whiteness value L* at t=0 was calculated. A higher percentage change in L* corresponded to increased crystallization on the surface of the film-coated substrate. It was discovered that films with a change in L* value of no more than about 20% typically exhibited reduced crystal formation on the surface of the film-coated substrate. For example, films having a change in L* value of no more than about 20%, no more than about 18%, no more than about 16%, no more than about 15%, no more than about 14%, no more than about 13%, no more than about 12%, no more than about 11%, no more than about 10%, no more than about 9%, or no more than about 8% typically exhibit acceptable inhibition and/or reduction in crystal formation.

A composition having a percentage change in L* as described above (e.g., no more than 20% when cast as a film) generally indicates that when the composition is applied to a seed, the surface of the seed will also exhibit acceptable inhibition and/or reduction in crystal formation.

### Example 1: Preparation and Evaluation of Aqueous Nematicidal Compositions Comprising Certain Polyarylphenol Alkoxylates in Combination with a Second Dispersant

The compositions of Example 1 were prepared to evaluate the comparative inhibition and/or reduction in crystal growth by utilizing a phosphonated tristyrylphenol ethoxylate (SOPROPHOR FLK), tristyrylphenol ethoxylate (SOPROPHOR S25/80), or sulfonated polyarylphenol ethoxylate (SOPROPHOR 4D 384) in combination with a second dispersant. Each treatment composition of Example 1 contained 0.75 wt % of AGNIQUE DFM 111S (an antifoam agent), 5.00 wt % of propylene glycol (an antifreeze agent), and 0.15 wt % of KELZAN S PLUS (1%).

Tables 1 and 3 report compositions comprising the polyarylphenol alkoxylates in combination with various lignin sulfonates (GREENSPERSE S7, REAX 907, or POLYFON O). Table 2 reports compositions comprising the polyarylphenol alkoxylates in combination with either a lignin sulfonate or a copolymer of maleic acid and olefin (SOKALAN CP 9). Tables 1 and 2 report the percentage change in L* after 4 and 14 days, while Table 3 reports the percentage change in L* after 7 and 14 days.

TABLE 1

| | Composition Number | | | | | | | | |
|---|---|---|---|---|---|---|---|---|---|
| | NS25 | NS26 | NS27 | NS28 | NS29 | NS30 | NS32 | NS33 | NS34 |
| SOPROPHOR | — | — | — | — | — | — | 2.06% | 2.06% | 2.06% |
| FLK | | | | | | | | | |
| SOPROPHOR | 2.06% | 2.06% | 2.06% | — | — | — | — | — | — |
| S25/80 | | | | | | | | | |
| SOPROPHOR | — | — | — | 2.06% | 2.06% | 2.06% | — | — | — |
| 4D 384 | | | | | | | | | |
| GREENSPERSE | 2.06% | — | — | 2.06% | — | — | 2.06% | — | — |
| S7 | | | | | | | | | |
| REAX 907 | — | 2.06% | — | — | 2.06% | — | — | 2.06% | — |
| POLYFON O | — | — | 2.06% | — | — | 2.06% | — | — | 2.06% |
| L* change | 1.8% | 5.7% | 5.4% | 1.3% | 2.1% | 2.9% | 2.8% | 11.1% | 5.8% |
| after 4 days | | | | | | | | | |
| L* change | 1.6% | 7.6% | 7.6% | 1.4% | 2.2% | 3.5% | 3.4% | 13.4% | 6.4% |
| after 14 days | | | | | | | | | |

TABLE 2

| | Composition Number | | | | | | | | |
|---|---|---|---|---|---|---|---|---|---|
| | NS35 | NS36 | NS37 | NS38 | NS39 | NS40 | NS41 | NS42 | NS43 |
| SOPROPHOR | — | — | 2.73% | — | — | — | — | — | — |
| FLK | | | | | | | | | |
| SOPROPHOR | 2.73% | — | — | 4.87% | 4.87% | 4.87% | — | — | — |
| S25/80 | | | | | | | | | |
| SOPROPHOR | — | 2.73% | — | — | — | — | 4.87% | 4.87% | 4.87% |
| 4D 384 | | | | | | | | | |
| GREENSPERSE | — | — | — | 0.86% | — | — | 0.86% | — | — |
| S7 | | | | | | | | | |
| REAX 907 | — | — | — | — | 0.86% | — | — | 0.86% | — |
| POLYFON O | — | — | — | — | — | 0.86% | — | — | 0.86% |
| SOKALON CP | 3.00% | 3.00% | 3.00% | — | — | — | — | — | — |
| 9 (25%) | | | | | | | | | |
| L* change | 0.1% | 1.4% | 1.9% | 1.1% | 2.4% | 1.9% | 5.0% | 5.8% | 6.7% |
| after 4 days | | | | | | | | | |
| L* change | −0.5% | 0.9% | 1.3% | 1.2% | 3.0% | 2.5% | 7.1% | 8.5% | 10.4% |
| after 14 days | | | | | | | | | |

TABLE 3

| | Composition Number | | |
|---|---|---|---|
| | NS44 | NS45 | NS46 |
| SOPROPHOR FLK | 4.87% | 4.87% | 4.87% |
| GREENSPERSE S7 | 0.86% | — | — |
| REAX 907 | — | 0.86% | — |
| POLYFON O | — | — | 0.86% |
| L* change after 7 days | 10.6% | 11.2% | 11.7% |
| L* change after 14 days | 14.7% | 15.9% | 16.3% |

### Example 2: Evaluation of Particle Size and Viscosity of Compositions of Example 1

Several of the compositions of Example 1 were also evaluated for stability. The particle size and dynamic viscosity (at 100 s⁻¹) were measured before and after the composition was subjected to 54° C. heat for a period of two weeks (i.e., “heat aging”). The results are reported below in Table 4. “N/A” indicates that the particle size and/or viscosity were not measured after heat aging or that the composition was not subjected to heat aging.

The particle size was measured using a BECKMAN COULTER LS Particle Size Analyzer (model LS 13 320).

The viscosity was measured using a HR-2 Discovery Hybrid Rheometer (commercially available from TA Instruments, New Castle, Del.)

TABLE 4

| | | Median | | |
|---|---|---|---|---|
| | | Particle | | |
| | Median | Size | | |
| | Particle | after heat | | Viscosity after |
| Composition | Size | aging | Viscosity | heat aging |
| Number | (μm) | (μm) | (centipoise, cP) | (centipoise, cP) |
| NS25 | 4.503 | 5.378 | 88.884 | 80.098 |
| NS26 | 4.164 | N/A | 80.284 | N/A |
| NS27 | 4.418 | N/A | 76.352 | N/A |
| NS28 | 3.832 | N/A | 63.45 | N/A |
| NS29 | 3.779 | N/A | 71.324 | N/A |
| NS30 | 4.207 | N/A | 65.764 | N/A |
| NS32 | 3.720 | N/A | 65.121 | N/A |
| NS33 | 3.316 | N/A | 63.572 | N/A |
| NS34 | 2.846 | N/A | 87.512 | N/A |
| NS35 | 3.337 | 4.975 | 112.292 | 103.545 |
| NS36 | 3.625 | N/A | 115.325 | N/A |
| NS37 | 3.503 | 5.076 | 126.115 | 114.878 |
| NS38 | 4.664 | 5.542 | 90.748 | 85.215 |
| NS39 | 4.590 | N/A | 90.3 | N/A |
| NS40 | 4.830 | N/A | 106.017 | N/A |
| NS41 | 4.249 | N/A | 95.556 | N/A |
| NS42 | 3.631 | N/A | 91.06 | N/A |
| NS43 | 3.309 | N/A | 88.666 | N/A |
| NS44 | 4.017 | N/A | 76.749 | N/A |
| NS45 | 4.001 | N/A | 73.404 | N/A |
| NS46 | 3.950 | N/A | 77.185 | N/A |

Typically, a significant increase in particle size and/or increase in viscosity after heat aging may indicate that the individual 3,5-disubstituted-1,2,4-oxadiazole particles have aggregated to form larger particles, which may precipitate from the composition. As set forth above, stability is generally defined as the absence of sedimentation and the lack of any significant change in the rheological properties of the composition.

The results of Table 4 demonstrate that the tested compositions maintained acceptable commercial stability even after heat aging at 54° C.

### Example 3: Preparation and Evaluation of Certain Polyarylphenol Alkoxylates in Combination with a Second Dispersant

An experiment similar to Example 1 was performed utilizing different combinations of dispersants as well as varying amounts of the polyarylphenol alkoxylate. The compositions were used to form a film as described above and evaluated for crystal growth at 7 and 14 days after application as described in Example 1.

Each treatment composition of Example 3 contained 0.75 wt % of AGNIQUE DFM 111S (an antifoam agent) and 5.00 wt % of propylene glycol (an antifreeze agent).

The contents of each composition and the results are set forth below in Tables 5-7.

TABLE 5

| | Composition Number | | | | | |
|---|---|---|---|---|---|---|
| | NS69 | NS12 | NS70 | NS71 | NS25(2) | NS28(2) |
| SOPROPHOR 4D | 2.50% | 2.50% | — | — | — | 2.06% |
| 384 | | | | | | |
| SOPROPHOR FLK | — | — | 4.23% | — | — | — |
| SOPROPHOR S25/80 | — | — | — | 4.87% | 2.06% | — |
| HYACT | 2.50% | 2.50% | 1.34% | — | — | — |
| GREENSPERSE S7 | — | — | — | 0.86% | 2.06% | 2.06% |
| KELZAN CC (1%) | 0.12% | 0.13% | 0.13% | 0.13% | 0.13% | 0.13% |
| L* change | 5.6% | 3.6% | 5.3% | 2.6% | 7.8% | 6.5% |
| after 7 days | | | | | | |
| L* change | 6.9% | 5.1% | 5.6% | 4.0% | 9.8% | 8.1% |
| after 14 days | | | | | | |

TABLE 6

| | Composition Number | | | | | |
|---|---|---|---|---|---|---|
| | NS72 | NS35(2) | NS37(2) | NS73 | NS74 | NS75 |
| SOPROPHOR 4D | — | — | — | — | — | 2.50% |
| 384 | | | | | | |
| SOPROPHOR FLK | — | — | 2.73% | — | — | — |
| SOPROPHOR | 2.06% | 2.73% | — | 4.87% | 2.73% | — |
| S25/80 | | | | | | |
| HYACT | — | — | — | — | — | 2.50% |
| GREENSPERSE | 2.06% | — | — | 0.86% | — | — |
| S7 | | | | | | |
| SOKALON CP 9 | — | 3.00% | 3.00% | — | 3.00% | — |
| (25%) | | | | | | |
| EASY SPERSE 20 | — | — | — | — | — | 1.00% |
| KELZAN CC | 0.13% | 0.13% | 0.13% | 0.13% | 0.13% | 0.13% |
| (1.5%) | | | | | | |
| L* change | 3.6% | 3.3% | 4.1% | 5.2% | 2.3% | 4.6% |
| after 7 days | | | | | | |
| L* change | 4.5% | 3.5% | 4.7% | 5.9% | 2.5% | 6.0% |
| after 14 days | | | | | | |

TABLE 7

| | Composition Number | | | |
|---|---|---|---|---|
| | G2-52 | G2-53 | G2-54 | G2-60 |
| SOPROPHOR 3D-33 | 3.50% | 2.00% | — | — |
| SOPROPHOR FLK | — | — | 4.50% | 4.50% |
| SOKALAN K30 | — | — | — | 1.50% |
| EASYSPERSE P20 | — | — | 1.50% | — |
| POLYFON O | 2.50% | 4.00% | — | — |
| KELZAN CC (1.5%) | 0.13% | 0.13% | 0.13% | 0.13% |
| L* change after 7 days | 6.5% | 5.2% | 6.5% | 6.5% |
| L* change after 14 days | 13.3% | 9.0% | 10.7% | 11.0% |

### Example 4: Preparation and Evaluation of Certain Dispersants and/or Dispersant Combinations

A further experiment was performed in accordance with the procedure of Example 1, utilizing various dispersants and/or dispersant combinations.

Each treatment composition of Example 4 contained 0.75 wt % of AGNIQUE DFM 111S (an antifoam agent) and 5.00 wt % of propylene glycol (an antifreeze agent).

A value of “N/A” is meant to indicate that the sample was not evaluated for that specified time period. The contents of each compositions, the median panicle size after forming the composition, and the L* change at 7 and 14 days are reported below in Tables 8-13.

TABLE 8

| | Composition Number | | | | | | | | |
|---|---|---|---|---|---|---|---|---|---|
| | G2-21 | G2-22 | G2-23 | G2-24 | G2-25 | G2-26 | G2-30 | G2-31 | G2-32 |
| SOPROPHOR | 5.00% | — | — | — | — | — | — | — | — |
| 3D-33 | | | | | | | | | |
| SOPROPHOR | — | 5.00% | — | — | 3.00% | 3.00% | 3.50% | 3.50% | 3.50% |
| FLK | | | | | | | | | |
| SOPROPHOR | — | — | 5.00% | — | — | — | — | — | — |
| 4D 384 | | | | | | | | | |
| TERSPERSE | — | — | — | 5.00% | — | — | — | — | — |
| 2202 | | | | | | | | | |
| AGRIMIER VA | — | — | — | — | 3.00% | — | — | — | — |
| 6W (50% IN | | | | | | | | | |
| WATER) | | | | | | | | | |
| SOKALAN | — | — | — | — | — | 3.00% | — | — | — |
| VA 64 (95% | | | | | | | | | |
| POWDER) | | | | | | | | | |
| ATLOX 4913 | — | — | — | — | — | — | 3.50% | — | — |
| SOKALAN K | — | — | — | — | — | — | — | 3.50% | — |
| 30 | | | | | | | | | |
| ATLOX | — | — | — | — | — | — | — | — | 3.50% |
| METASPERSE | | | | | | | | | |
| 500L | | | | | | | | | |
| KELZAN CC | 0.13% | 0.13% | 0.13% | 0.13% | 0.13% | 0.13% | 0.13% | 0.13% | 0.13% |
| (1%) | | | | | | | | | |
| Median Particle | 2.42 | 2.54 | 2.49 | 2.57 | 2.31 | 2.24 | 2.22 | 2.710 | 2.390 |
| Size (μm) | | | | | | | | | |
| L* change | 2.7% | 4.0% | 3.5% | 2.9% | 5.4% | 4.5% | 4.9% | 3.1% | 4.8% |
| after 7 days | | | | | | | | | |
| L* change | 5.5% | 8.2% | 6.3% | 5.3% | 9.1% | 7.6% | 10.0% | 4.4% | 9.3% |
| after 14 days | | | | | | | | | |

TABLE 9

| | Composition Number | |
|---|---|---|
| | G2-33 | G2-40 |
| SOPROPHOR 3D-33 | — | 3.50% |
| SOPROPHOR 4D 384 | 3.00% | — |
| POLYFON O | 3.00% | — |
| KELZAN CC (1%) | 0.13% | 0.13% |
| Median Particle Size (μm) | 2.4 | 2.490 |
| L* change after 7 days | 5.1% | 3.4% |
| L* change after 14 days | 4.9% | 3.9% |

TABLE 10

| | Composition Number | | | | | | |
|---|---|---|---|---|---|---|---|
| | G2-42 | G2-44 | G2-46 | G2-47 | G2-48 | G2-57 | G2-59 |
| SOPROPHOR | 3.50% | — | — | — | — | 2.00% | 2.00% |
| FLK | | | | | | | |
| SOPROPHOR | — | 3.50% | 5.00% | 4.00% | 2.00% | — | — |
| 4D 384 | | | | | | | |
| SOKALAN VA | — | — | — | — | — | 4.00% | — |
| 64 (96% | | | | | | | |
| POWDER) | | | | | | | |
| SOKALAN K 30 | — | — | — | — | — | — | 4.00% |
| POLYFON O | — | — | 1.00% | 2.00% | 4.00% | — | — |
| KELZAN CC | 0.13% | 0.13% | 0.13% | 0.13% | 0.13% | 0.13% | 0.13% |
| (1.5%) | | | | | | | |
| Median Particle | 3.01 | 2.65 | 2.32 | 2.05 | 2.14 | 2.360 | 2.430 |
| Size (μm) | | | | | | | |
| L* change | 5.9% | 4.2% | 5.5% | 4.7% | 7.7% | 3.4% | 3.2% |
| after 7 days | | | | | | | |
| L* change | 9.2% | 5.7% | 8.8% | 6.5% | 8.3% | 4.6% | 4.4% |
| after 14 days | | | | | | | |

TABLE 11

| | | Composition Number | | | | | | |
|---|---|---|---|---|---|---|---|---|
| | G2-68 | G2-69 | G2-70 | G2-73 | G2-75 | G2-77 | G2-78 | G2-80 |
| SOPROPHOR | — | — | — | 2.00% | 3.00% | 7.00% | 5.00% | 8.00% |
| 4D 384 | | | | | | | | |
| SOKALAN | — | — | — | 4.00% | — | — | — | — |
| VA 64 (95% | | | | | | | | |
| POWDER) | | | | | | | | |
| POLYFON O | 1.00% | 2.00% | 3.50% | — | — | — | — | — |
| PLURONIC | 4.00% | 3.00% | 1.50% | — | — | — | — | — |
| L1060 | | | | | | | | |
| SOKALAN K | — | — | — | — | 3.00% | — | — | — |
| 30 | | | | | | | | |
| KELZAN CC | 0.13% | 0.13% | 0.13% | 0.13% | 0.13% | 0.13% | 0.13% | 0.13% |
| (1.5%) | | | | | | | | |
| Median | 3.0 | 2.650 | 2.68 | 2.6 | 2.500 | 2.400 | 2.600 | N/A |
| Particle Size | | | | | | | | |
| (μm) | | | | | | | | |
| L* change | 4.4% | 4.8% | 6.1% | 1.0% | 0.0% | 2.8% | 4.4% | 2.6% |
| after 7 days | | | | | | | | |
| L* change | 5.2% | 5.5% | 7.2% | 1.6% | 0.6% | 5.7% | 7.5% | 4.9% |
| after 14 days | | | | | | | | |

TABLE 12

| | Composition Number | | | | | | |
|---|---|---|---|---|---|---|---|
| | NS40 | G2-71 | G2-72 | G2-74 | G2-76 | G2-57 | G2-59 |
| SOPROPHOR | 4.87% | — | — | — | — | — | — |
| S25/80 | | | | | | | |
| SOPROPHOR | — | 5.00% | 3.00% | 5.00% | 2.00% | — | — |
| 4D 384 | | | | | | | |
| SOPROPHOR | — | — | — | — | — | 2.00% | 2.00% |
| FLK | | | | | | | |
| SOKALAN | — | 1.00% | 3.00% | — | — | 4.00% | — |
| VA 64 (95% | | | | | | | |
| POWDER) | | | | | | | |
| SOKALAN K | — | — | — | 1.00% | 4.00% | — | 4.00% |
| 30 | | | | | | | |
| POLYFON O | 0.86% | — | — | — | — | — | — |
| KELZAN S | 0.15% | 0.13% | 0.13% | 0.13% | 0.13% | 0.13% | 0.13% |
| PLUS (1%) | | | | | | | |
| L* change | 1.9% | 1.0% | 1.3% | 0.59% | 0.75% | 3.4% | 3.2% |
| after 7 days | | | | | | | |
| L* change | 2.5% | 1.9% | 2.1% | 1.7% | 0.9% | 4.6% | 4.4% |
| after 14 days | | | | | | | |

TABLE 13

| | Composition Number | | | | |
|---|---|---|---|---|---|
| | G2-33 | G2-1 | G2-4 | G2-5 | G2-6 |
| SOPROPHOR 4D 384 | 3.00% | | — | — | 2.50% |
| SOPROPHOR FLK | — | — | — | 2.50% | — |
| SOPROPHOR 3D-33 | — | — | 2.50% | — | — |
| TERSPERSE 2500 | — | 2.50% | 2.50% | 2.50% | 2.50% |
| TERSPERSE 4894 | — | 2.50% | — | — | — |
| POLYFON O | 3.00% | — | — | — | — |
| KELZAN S PLUS (1%) | 0.13% | 0.13% | 0.13% | 0.13% | 0.13% |
| L* change after 7 days | 5.1% | N/A | N/A | N/A | N/A |
| L* change after 14 days | 4.9% | 4.5% | 4.3% | 5.9% | 4.5% |

### Example 5: Dispersant Package Evaluation

A further experiment was performed in accordance with the procedures set forth in Example 1, wherein compositions comprising various dispersant packages were used to form a film as described above and evaluated for crystal growth at 7 and 14 days after application.

Each treatment composition of Example 5 contained 5.00 wt % propylene glycol (an antifreeze agent).

The contents of each compositions as well as the L* change at 7 and 14 days are reported below in Table 14-17. A value of “N/A” is meant to indicate that the sample was not evaluated for that specified time period. AGNIQUE NSC 11 NP (commercially available from BASF) is a naphthalene sulfonate condensate and AGNIQUE NSC 3 NP (commercially available from BASF or Cognis) is naphthalene sulfonate condensate sodium salt.

TABLE 14

| | Composition Number | | | | |
|---|---|---|---|---|---|
| | NS58 | NS59 | NS60 | NS61 | NS62 |
| SOPROPHOR S25/80 | 2.50% | 2.50% | 2.50% | 2.50% | 2.00% |
| ATLOX 4913 | — | — | — | — | 3.00% |
| AGNIQUE NSC 3 NP | — | — | 3.00% | 5.00% | — |
| AGNIQUE NSC 11 NP | 3.00% | 5.00% | — | — | — |
| AGNIQUE DFM 111S | 0.75% | 0.75% | 0.75% | 0.75% | 0.75% |
| KELZAN S PLUS (1%) | 0.15% | 0.15% | 0.15% | 0.15% | 0.15% |
| L* change after 7 days | 13.17% | 21.05% | 18.85% | 15.34% | 8.11% |
| L* change after 14 days | 14.44% | 21.53% | 19.46% | 15.62% | 9.28% |

TABLE 15

| | Composition Number | | | |
|---|---|---|---|---|
| | NS68 | NS81 | NS83 | NS112 |
| SOPROPHOR 4D 384 | — | — | 3.00% | — |
| HYACT | — | — | — | 6.00% |
| ATLOX 4913 | 2.50% | 1.40% | — | — |
| ATLOX METASPERSE 500L | 3.25% | — | — | — |
| PLURIOL P106 | — | 3.50% | 1.00% | — |
| BENTONITE | 1.00% | 0.50% | 0.50% | — |
| AGNIQUE DFM 111S | 0.75% | 0.75% | 0.75% | 0.50% |
| KELZAN CC (1%) | 0.12% | — | — | 0.12% |
| KELZAN S PLUS (1%) | — | 0.15% | 0.15% | — |
| L* change after 7 days | 17.7% | 39.01% | 38.88% | 57.34% |
| L* change after 14 days | 18.8% | 39.57% | 39.12% | 54.05% |

TABLE 16

| | Composition Number | | |
|---|---|---|---|
| | G2-9 | G2-16 | G2-17 |
| TERSPERSE 2500 | 2.50% | — | — |
| SOPROPHOR FLK | — | 2.50% | 2.50% |
| ATLOX METASPERSE | — | 2.50% | — |
| 500L | | | |
| PLURONIC L64 | 2.50% | — | 2.50% |
| SOKALAN K 30 | — | — | — |
| AGNIQUE DFM 111S | 0.75% | 0.75% | 0.75% |
| KELZAN CC (1%) | 0.13% | 0.13% | 0.13% |
| L* change after 14 days | 10.1% | 9.9% | 11.0% |

TABLE 17

| | Composition Number | | | | | | | |
|---|---|---|---|---|---|---|---|---|
| | G2-65 | G2-43 | G2-7 | G2-11 | G2-18 | G2-27 | G2-34 | G2-79 |
| SOPROPHOR 4D | — | — | — | — | 2.50% | — | — | 3.00% |
| 384 | | | | | | | | |
| SOPROPHOR FLK | | 3.50% | — | — | — | 3.00% | — | — |
| GREENSPERSE S7 | 1.00% | — | — | — | — | — | — | — |
| POLYFON O | — | — | — | — | — | — | 3.00% | — |
| PLURONIC L1060 | 4.00% | — | — | — | — | — | — | — |
| MORWET D425 | — | 0.50% | — | — | — | 3.00% | — | — |
| TERSPERSE 2500 | — | — | 2.50% | 2.50% | — | — | 3.00% | — |
| ATLOX | — | — | 2.50% | — | — | — | — | — |
| METASPERSE 500L | | | | | | | | |
| AGNTQUE DFM | 0.75% | 0.75% | 0.75% | 0.75% | 0.75% | 0.75% | 0.75% | 0.75% |
| ms | | | | | | | | |
| KELZAN CC (1.5%) | 0.13% | 0.13% | 0.13% | 0.13% | 0.13% | 0.13% | 0.13% | 0.13% |
| L* change | 10.3% | 14.7% | N/A | N/A | N/A | 23.6% | 7.4% | 6.3% |
| after 7 days | | | | | | | | |
| L* change | 15.8% | 20.9% | 35.5% | 34.7% | 22.9% | 39.5% | 12.5% | 9.8% |
| after 14 days | | | | | | | | |

When introducing elements of the present invention or the embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and the associated drawings shall be interpreted as illustrative and not in a limiting sense.

1. An aqueous nematicidal composition, the composition comprising:
a continuous aqueous phase comprising a dispersant component, the dispersant component comprising a polyarylphenol alkoxylate or salt thereof and a second dispersant; and
a dispersed solid particulate phase comprising a 3,5-disubstituted-1,2,4-oxadiazole or a salt thereof.

2. The composition of claim 1, wherein the polyarylphenol alkoxylate is a sulfonated or phosphonated polyarylphenol alkoxylate.

3. The process of claim 1, wherein the polyarylphenol alkoxylate is a tristyrylphenol alkoxylate.

4. The composition of claim 1, wherein the polyarylphenol alkoxylate is a polyarylphenol ethoxylate.

5. The composition of claim 1, wherein the polyarylphenol alkoxylate is in the form of an ammonium, potassium, sodium, or trimethylamine salt.

6. The composition of claim 1, wherein the second dispersant is selected from the group consisting of lignin sulfonates, polyvinylpyrrolidone (PVP) polymers, polyvinylpyrrolidone/vinylacetate (PVP/VA) copolymers, maleic acid/olefin polymers, comb-graft copolymers, propylene oxide block copolymers, salts thereof, and combinations thereof.

7. The composition of claim 6, wherein the second dispersant comprises a lignin sulfonate selected from the group consisting of a sodium lignosulfonate, calcium lignosulfonate, ammonium lignosulfonate, magnesium lignosulfonate, potassium lignosulfonate, or sulfomethylated lignosulfonate.

8. (canceled)

9. The composition of claim 6, wherein the second dispersant comprises a maleic acid/olefin polymer selected from the group consisting of diisobutene, acrylic acid, and olefin copolymers.

10. (canceled)

11. The composition of claim 6, wherein the second dispersant comprises a comb-graft copolymer comprising an acrylic graft copolymer.

12. (canceled)

13. The composition of claim 6, wherein the second dispersant comprises a propylene oxide block copolymer selected from the group consisting of ethylene oxide, propylene oxide, and amine based block copolymers.

14. (canceled)

15. The composition of claim 1, wherein the dispersant component further comprises a third dispersant selected from the group consisting of lignin sulfonates, polyvinylpyrrolidone (PVP) polymers, polyvinylpyrrolidone/vinylacetate (PVP/VA) copolymers, maleic acid/olefin polymers, comb-graft copolymers, propylene oxide block copolymers, salts thereof, and combinations thereof.

16. The composition of claim 15, wherein the third dispersant comprises a polyvinylpyrrolidone (PVP) polymer or a maleic acid/olefin polymer.

17. The composition of claim 1 wherein the dispersant component comprises from about 0.5 wt % to about 20 wt %, from about 0.5 wt % to about 10 wt %, from about 1 wt % to about 9 wt %, from about 1.5 wt % to about 8 wt %, or from about 2 wt % to about 8 wt % of the composition.

18. The composition of claim 1 wherein the second dispersant comprises from about 0.05 wt % to about 10 wt %, from about 0.1 wt % to about 10 wt %, from about 0.5 wt % to about 8 wt %, from about 1 wt % to about 5 wt %, or from about 2 wt % to about 5 wt % of the composition.

19. The composition of claim 1 wherein the ratio of polyarylphenol alkoxylate to second dispersant, on a weight basis, is from about 1:5 to about 10:1, from about 1:4 to about 9:1, from about 1:2 to about 8:1, from about 1:1 to about 5:1, from about 2:1 to about 5:1, or from about 2:1 to about 3:1.

20. The composition of claim 1 wherein the dispersed solid particulate phase comprises a compound of Formula I or a salt thereof, 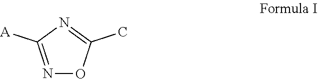
wherein A is selected from the group consisting of phenyl, pyridyl, pyrazyl, oxazolyl and isoxazolyl, each of which can be optionally independently substituted with one or more substituents selected from the group consisting of halogen, CF₃, CH₃, OCF₃, OCH₃, CN, and C(H)O; and C is selected from the group consisting of thienyl, furanyl, oxazolyl and isoxazolyl, each of which can be optionally independently substituted with one or more substituents selected from the group consisting of F, Cl, CH₃, and OCF₃.

21. (canceled)

22. The composition of claim 20 wherein the dispersed solid particulate phase comprises 3-phenyl-5-(thiophen-2-yl)-1,2,4-oxadiazole.

23. The composition claim 1 wherein the dispersed solid particulate phase comprises at least about 10%, at least about 15%, at least about 20%, at least about 25%, at least about 30%, at least about 35%, at least about 40%, at least about 45%, or at least about 50% by weight of the composition.

24. The composition of claim 1, wherein the dispersed solid particulate phase comprises 3-phenyl-5-(thiophen-2-yl)-1,2,4-oxadiazole, the dispersant component comprises a polyarylphenol alkoxylate or salt thereof selected from the group consisting of phosphate triethanolamine, tristyrylphenol ethoxylate, ethoxylated tristyrylphenol phosphate, polyarylphenylether sulphate, naphthalene sulfonate and the ammonium, potassium, sodium or trimethylamine salts thereof, and the second dispersant is selected from the group consisting of kraft lignin, sodium lignosulfonate, polyvinyl pyrrolidone, copovidone, composite polyvinyl pyrrolidone (PVP) and methyl vinyl ether/maleic acid half ester, co-polymer of metacic acid and olefin, ethylene oxide/propylene oxide block copolymer, and non-ionic acrylic copolymer.

25. The composition of claim 1 wherein the mean particle size of the dispersed solid particulate phase is from about 0.5 μm to about 20 μm, from about 0.5 μm to about 10 μm, from about 1 μm to about 5 μm, from about 1 μm to about 4 μm, or from about 1 μm to about 3 μm, or from about 1 μm to about 2 μm.

26. A method of preparing the aqueous nematicidal composition of claim 1, the method comprising:
mixing the dispersed solid particulate phase comprising a 3,5-disubstituted-1,2,4-oxadiazole or a salt thereof, the dispersant component, and water to form an aqueous composition.

27. The method of claim 26 wherein the aqueous composition is wet milled to produce a milled composition having a reduced particle size.

28. A method for protecting the roots of a plant against damage by a nematode, the method comprising applying the aqueous nematicidal composition of claim 1 to the soil surrounding the root zone of a plant.

29. A method for protecting a seed and/or the roots of a plant grown from the seed against damage by a nematode, the method comprising treating a seed with an aqueous nematicidal composition of claim 1.

30-37. (canceled)

38. An aqueous nematicidal composition, the composition comprising:
a continuous aqueous phase comprising a dispersant component, the dispersant component comprising a sulfonated polyarylphenol ethoxylate or salt thereof and a second dispersant comprising a polyvinylpyrrolidone/vinylacetate (PVP/VA) copolymer; and
a dispersed solid particulate phase comprising a 3,5-disubstituted-1,2,4-oxadiazole or a salt thereof.

39. A treated seed comprising a nematicidal coating composition adhered to the surface of the seed, the nematicidal coating composition comprising:
a continuous aqueous phase comprising a dispersant component, the dispersant component comprising a polyarylphenol alkoxylate or salt thereof and a second dispersant; and
a dispersed solid particulate phase comprising a 3,5-disubstituted-1,2,4-oxadiazole or a salt thereof.
